(19) United States
(12) Patent Application Publication
(10) Pub. No.: US 2024/0399254 A1
(43) Pub. Date: Dec. 5, 2024

(54) VIRTUAL SCENE MESSAGE PROCESSING METHOD, APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Chenghao Ye, Shenzhen (CN); Ziyi WANG, Shenzhen (CN); Weijian CUI, Shenzhen (CN); Shuai HAN, Shenzhen (CN); Shengyu WU, Shenzhen (CN); Jingjing HE, Shenzhen (CN)

(21) Appl. No.: 18/770,426

(22) Filed: Jul. 11, 2024

Related U.S. Application Data
(63) Continuation of application No. PCT/CN2023/083259, filed on Mar. 23, 2023.

(30) Foreign Application Priority Data
May 23, 2022 (CN) 20222105636126

(51) Int. Cl. A63F 13/5378; A63F 13/5372; A63F 13/55; G06T 17/05

(52) U.S. Cl. CPC A63F 13/5378; A63F 13/5372; A63F 13/55; G06T 17/05

(57) ABSTRACT

This application provides a method and an apparatus for message processing in a virtual scene, an electronic device, a computer-readable storage medium, and a computer program product. The method includes: causing display of a map of at least partial region of the virtual scene on a map interface corresponding to a first virtual object; causing display of, in response to at least one second virtual object appearing in the partial region, a position marking control configured to represent a first position at which the second virtual object is currently located in the map, the second virtual object being any virtual object belonging to the same camp as the first virtual object; and moving the position marking control from the first position to a second position in response to a movement operation performed on the position marking control, and transmitting a message to the second virtual object, the message being configured for instructing the second virtual object to arrive at the second position and execute an instruction.

### RELATED APPLICATION

This application is a continuation of and claims priority to PCT/CN2023/083259, filed Mar. 23, 2023, which claims priority to Chinese Patent Application No. 202210563612.6, filed on May 23, 2022, both of which are incorporated herein by reference in their entirety.

### FIELD OF THE TECHNOLOGY

This application relates to the field of computer technologies, and in particular, to a virtual scene message processing method, apparatus, electronic device, computer-readable storage medium, and/or computer program product.

### BACKGROUND OF THE DISCLOSURE

A display technology based on graphics processing hardware expands channels for environment sensing and information obtaining. In particular, a virtual scene display technology can achieve diversified interactions between virtual objects controlled by a user or artificial intelligence based on an actual application demand, and is applicable to various typical application scenarios. For example, the display technology can emulate a real combat process between virtual objects in a virtual scene such as a game.

In a virtual scene, a communication manner between users includes voice communication, shortcut marking within a round, shortcut messages, and the like. Since the messages are usually transmitted to all members in a same camp or team, some of the teammates may be disturbed by irrelevant messages. Although efficient communication with a specific teammate may be achieved through voice communication, terminal devices of some users may not be configured with hardware devices or software devices related to voice communication. The related art does not provide an efficient message transmission solution.

### SUMMARY

One or more aspects of this application provide a virtual scene message processing method, apparatus, electronic device, computer-readable storage medium, and/or computer program product, which can efficiently perform point-to-point message transmission in the virtual scene, thereby eliminating interference caused by a message to irrelevant users.

Technical solutions of the aspects of this application are implemented as follows:

An aspect of this application provides a method for message processing in a virtual scene, including:
causing display of a map of at least a partial region of the virtual scene on a map interface corresponding to a first virtual object;
causing display of, in response to at least one second virtual object appearing in the partial region, a position marking control configured to represent a first position at which the second virtual object is currently located in the map, the second virtual object belonging to a same camp as the first virtual object;
moving the position marking control from the first position to a second position in response to a movement operation performed on the position marking control;
transmitting a message to the second virtual object, the message configured to instruct the second virtual object to move to the second position and execute an instruction.

An aspect of this application provides an apparatus for message processing in a virtual scene, including:
a display module, configured to display a map of at least partial region of the virtual scene on a map interface corresponding to a first virtual object,
the display module being further configured to display, in response to at least one second virtual object appearing in the partial region, a position marking control configured to represent a first position at which the second virtual object is currently located in the map, the second virtual object being any virtual object belonging to the same camp as the first virtual object; and
a message transmission module, configured to move the position marking control from the first position to a second position in response to a movement operation performed on the position marking control, and transmit a message to the second virtual object, the message being configured for instructing the second virtual object to arrive at the second position and execute an instruction.

An aspect of this application provides an electronic device, including:
a memory, configured to store executable instructions; and
a processor, configured to perform the method for message processing in a virtual scene provided in one or more aspects of this application when executing the executable instructions stored in the memory.

An aspect of this application provides a computer-readable storage medium, having computer-executable instructions stored therein, the computer-executable instructions, when executed by a processor, implementing the method for message processing in a virtual scene provided in one or more aspects of this application.

An aspect of this application provides a computer program product, including a computer program or instructions, the computer program or the instructions, when executed by a processor, implementing the method for message processing in a virtual scene according to one or more aspects of this application.

One or more aspects of this application have the following beneficial effects:

The position marking control of the second virtual object in the same camp as the first virtual object is displayed on the map interface, and when the position marking control of the second virtual object is moved, the corresponding instruction and message are transmitted to the second virtual object based on the movement operation, which achieves shortcut transmission of the point-to-point message by using the map interface of the virtual scene. Compared to message transmission through voice transmission or text input in the related art, dragging the position marking control can more quickly and conveniently achieve shortcut message transmission, thereby reducing time required for message transmission.

Through message transmission to only the second virtual object, precise point-to-point message transmission is achieved, and interference with other virtual objects in the same camp is avoided.

The message is transmitted by reusing the position marking control on the map interface of the virtual scene. Compared to arrangement of a new control configured to transmit a message in a human-computer interaction interface, an interaction logic of the virtual scene is simplified, operation efficiency is improved, and point-to-point message transmission can be achieved without a need to use a radio device (for example, a microphone), thereby reducing computing resources required for the virtual scene.

### BRIEF DESCRIPTION OF THE DRAWINGS

FIG. 1A is a schematic diagram of an application mode of a method for message processing in a virtual scene according to an aspect of this application.

FIG. 1B is a schematic diagram of an application mode of a method for message processing in a virtual scene according to an aspect of this application.

FIG. 2 is a schematic structural diagram of a terminal device 400 according to an aspect of this application.

FIG. 3A to FIG. 3F are schematic flowcharts of a method for message processing in a virtual scene according to an aspect of this application.

FIG. 4A is a schematic diagram of a map interface displayed on a virtual scene interface according to an aspect of this application.

FIG. 4B is a schematic diagram of a map interface independent of a virtual scene interface according to an aspect of this application.

FIG. 5A to FIG. 5F are schematic diagrams of a map of a method for message processing in a virtual scene according to an aspect of this application.

FIG. 6A to FIG. 6J are schematic diagrams of a map of a method for message processing in a virtual scene according to an aspect of this application.

FIG. 7A is a schematic diagram of an arrangement of an instruction control according to an aspect of this application.

FIG. 7B is a schematic diagram of a virtual scene interface corresponding to a second virtual object according to an aspect of this application.

FIG. 8 is an optional schematic flowchart of a method for message processing in a virtual scene according to an aspect of this application.

### DETAILED DESCRIPTION

To make the objectives, technical solutions, and advantages of this application clearer, this application is further described in detail with reference to drawings. The described aspects are not to be construed as a limitation on this application. All other aspects obtained by a person of ordinary skill in the art without creative efforts fall within the protection scope of this application.

In the following description, “some aspects” is used, which describes subsets of all possible aspects, but it may be understood that “some aspects” may be the same subset or different subsets of all of the possible aspects, and may be combined with each other without conflict.

In the following description, a term “first/second/third” involved is merely configured for distinguishing between similar objects and does not represent a specific order of objects. “First/second/third” may be transposed in a specific order or a sequence when allowed, so that one or more aspects of this application described herein may be implemented in an order other than those illustrated or described herein.

One or more aspects of this application include relevant data such as user information and data fed back by users. When one or more aspects of this application are applied to specific products or technologies, user permission or consent needs to be obtained, and collection, use, and processing of the relevant data need to comply with relevant laws, regulations, and standards of relevant countries and regions.

Unless otherwise defined, meanings of all technical and scientific terms used in this specification are the same as those usually understood by a person skilled in the art of this application. The terms used in this specification are merely intended to describe objectives of one or more aspects of this application, and are not intended to limit this application.

Before one or more aspects of this application are further described in detail, terms involved in one or more aspects of this application are described. The terms involved in one or more aspects of this application are applicable to the following explanations.

1) Virtual scene: It is a scene different from the real world outputted by using a device. Visual sensing of the virtual scene may be formed through naked eyes or assistance of a device, for example, a two-dimensional image outputted by a display, and a three-dimensional image outputted by using stereoscopic display technologies such as stereoscopic projection, virtual reality, and augmented reality. In addition, various sensing emulating the real world such as auditory sensing, tactile sensing, olfactory sensing, and motion sensing may be formed through various possible hardware.

2) In response to: It is configured for indicating a condition or a status on which one or more to-be-performed operations rely. When the condition or the status is satisfied, the one or more operations may be performed in real time or have a set delay. Unless otherwise specified, an order in which a plurality of operations are performed is not limited.

3) Virtual object: It is an object that performs interactions in a virtual scene, which is controlled by a user or a robot program (such as an artificial intelligence-based robot program), and can keep still, move, and perform various behaviors in the virtual scene, such as various roles in a game.

4) Map: It is configured to display a terrain of at least partial region of a virtual scene and various elements (such as a building, a virtual carrier, and a virtual object) on the earth surface.

5) Point-to-point message: It is a message transmitted from one terminal device to another terminal device in a point-to-point manner.

Aspects of this application provide a method for message processing in a virtual scene, an apparatus for message processing in a virtual scene, an electronic device, a computer-readable storage medium, and a computer program product, which can efficiently perform point-to-point message transmission in the virtual scene, thereby eliminating interference caused by a message to irrelevant users.

The electronic device provided in one or more aspects of this application may be implemented as various types of user terminals such as a notebook computer, a tablet computer, a desktop computer, a set-top box, or a mobile device (such as a mobile phone, a portable music player, a personal digital assistant, a dedicated messaging device, a portable game device, or an on-board terminal), or may be implemented as a server.

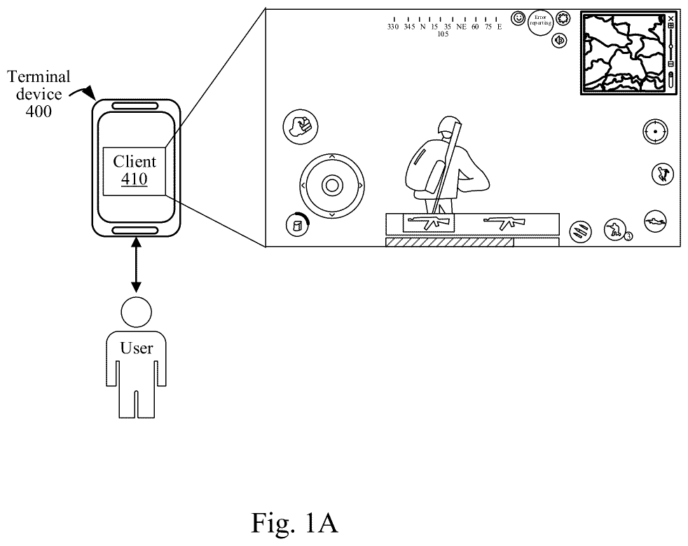

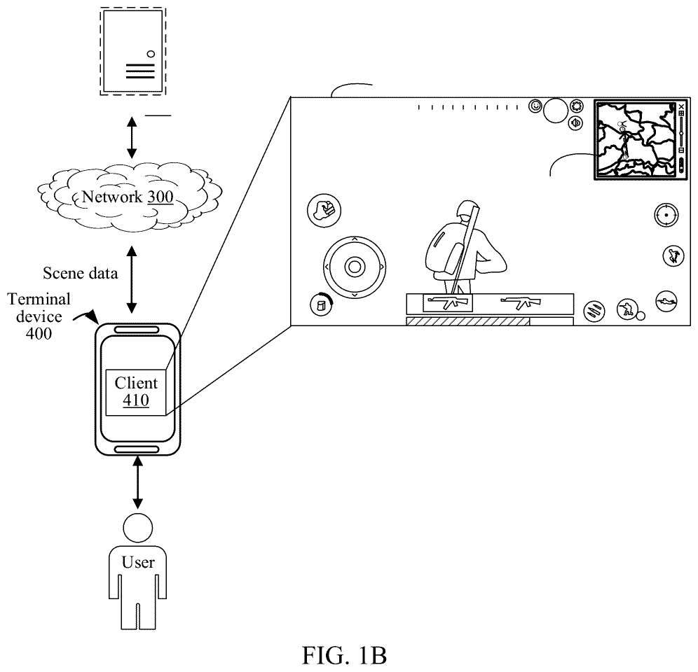

In an implementation scenario, FIG. 1A is a schematic diagram of an application mode of a method for message processing in a virtual scene according to an aspect of this application. The method is applicable to some application modes which completely rely on a computing capability of graphics processing hardware of a terminal device 400 to complete calculation of data related to a virtual scene. For example, in a game in a stand-alone mode or an off-line mode, outputting of a virtual scene is completed through various types of terminal devices 400 such as a smart phone, a tablet computer, a virtual reality device, and an augmented reality device.

In an example, types of the graphics processing hardware include a central processing unit (CPU) and a graphics processing unit (GPU).

In an example, a client 401 (for example, a stand-alone game application) runs in the terminal device 400. A virtual scene including role play is outputted during the running of the client 401. The virtual scene may be an environment for game roles to perform interaction, for example, may be a plain, a street, or a valley for battle between game roles. An example in which the virtual scene is displayed from a first-person perspective is used. A first virtual object and a launching prop (which may be, for example, a shooting prop or a throwing prop) held by the first virtual object through a holding part (such as a hand) are displayed in the virtual scene. The first virtual object may be a user-controlled game role. To be specific, the first virtual object is controlled by a real user, and moves in the virtual scene in response to an operation performed by the real user on a controller (such as a touch screen, a voice-activated switch, a keyboard, a mouse, or a joystick). For example, when the real user moves the joystick rightward, the first virtual object moves rightward in the virtual scene. The first virtual object can further keep still and jump, and be controlled to perform a shooting operation, and the like. A second virtual object is a virtual object in the same camp as the first virtual object. A map interface of the virtual scene is displayed in a partial region of a virtual scene interface in a form of a floating layer, or is displayed on an interface independent of the virtual scene interface.

For example, the first virtual object may be a user-controlled virtual object. The client 401 displays a map 102 of at least partial region of a virtual scene 101 on a map interface corresponding to the first virtual object; displays, in response to at least one second virtual object (which is in the same camp as the first virtual object) appearing in the partial region, a position marking control configured to represent a first position at which the second virtual object is currently located in the map; and moves the position marking control from the first position to a second position in response to a movement operation performed on the position marking control, and transmits a message to the second virtual object, the message carrying the second position and an instruction, and being configured for instructing the second virtual object to arrive at the second position and execute the instruction.

In another implementation scenario, FIG. 1B is a schematic diagram of an application mode of a method for message processing in a virtual scene according to an aspect of this application. The method is applied to a terminal device 400 and a server 200, and is applicable to an application mode which relies on a computing capability of the server 200 to complete calculation of the virtual scene and the virtual scene is outputted at the terminal device 400.

An example in which visual sensing of the virtual scene is formed is used. The server 200 calculates display data (such as scene data) related to the virtual scene and transmits the display data to the terminal device 400 through a network 300. The terminal device 400 relies on graphics computing hardware to complete loading, parsing, and rendering of the calculated display data, and relies on the graphics output hardware to output the virtual scene to form the visual sensing. For example, a two-dimensional video frame may be presented on a display of a smart phone, or a video frame with a three-dimensional display effect is projected onto lenses of augmented reality/virtual reality glasses. Sensing in the form of the virtual scene may be outputted by using corresponding hardware of the terminal device 400. For example, auditory sensing is formed by using a microphone, and haptic sensing is formed by using a vibrator.

For example, a client 401 (for example, a game application in a network version) runs in the terminal device 400. The client is connected to the server 200 (such as a game server) for game interactions with another user. The terminal device 400 outputs a virtual scene 101 of the client 401. A first virtual object and a launching prop (which may be, for example, a shooting prop or a throwing prop) held by the first virtual object through a holding part (such as a hand) are displayed in the virtual scene. The first virtual object may be a user-controlled game role. To be specific, the first virtual object is controlled by a real user, and moves in the virtual scene in response to an operation performed by the real user on a controller (such as a touch screen, a voice-activated switch, a keyboard, a mouse, or a joystick). For example, when the real user moves the joystick rightward, the first virtual object moves rightward in the virtual scene. The first virtual object can further keep still and jump, and be controlled to perform a shooting operation, and the like. A second virtual object is a virtual object in the same camp as the first virtual object. A map interface of the virtual scene is displayed in a partial region of a virtual scene interface in a form of a floating layer, or is displayed on an interface independent of the virtual scene interface. In FIG. 1B, a map 102 is displayed in the virtual scene 101 in a form of a floating layer.

For example, the first virtual object may be a user-controlled virtual object. The client 401 displays a map 102 of at least partial region of a virtual scene 101 on a map interface corresponding to the first virtual object; displays, in response to at least one second virtual object (which is in the same camp as the first virtual object) appearing in the partial region, a position marking control configured to represent a first position at which the second virtual object is currently located in the map; and moves the position marking control from the first position to a second position in response to a movement operation performed on the position marking control, and transmits a message to the second virtual object, the message carrying the second position and an instruction, and being configured for instructing the second virtual object to arrive at the second position and execute the instruction.

An example in which a computer program is an application is used. An application supporting a virtual scene runs in the terminal device 400. The application may be any one of a first-person shooting game (FPS), a third-person shooting game, a virtual reality application, a three-dimensional map program, or a multiplayer survival game. A user controls a virtual object located in the virtual scene to perform an activity by using the terminal device 400. The activity includes but is not limited to at least one of adjusting a body posture, crawling, walking, running, riding, jumping, driving, pickup, shooting, attacking, throwing, and constructing a virtual building. Exemplarily, the virtual object may be a virtual character, such as a simulated character or a cartoon character.

In some other aspects, this aspect of this application may be implemented through a cloud technology. The cloud technology is a hosting technology that unifies a series of resources such as hardware, software, and a network in a wide area network or a local area network to realize data computing, storage, processing, and sharing.

The cloud technology is a collective name of a network technology, an information technology, an integration technology, a platform management technology, an application technology, and the like based on application of business models for cloud computing. The technologies may form a resource pool for use on demand, which is flexible and convenient. A cloud computing technology becomes an important support. Backend services of a technology network system require a lot of computing and storage resources. Cloud gaming may also be referred to as gaming on demand, which is an online gaming technology based on the cloud computing technology. The cloud gaming technology enables a thin client with relatively limited graphics processing and data computing capabilities to run high-quality games. In a cloud game scene, a game runs in a cloud server rather than a game terminal of a player, and the cloud server renders the game scene into video and audio streams, and transfers the video and audio streams to the game terminal of the user through the network. The game terminal of the player is not required to have powerful graphics computing and data processing capabilities, but only required to have a basic streaming media playback capability and a capability of obtaining instructions inputted by the player and transmitting the instructions to the cloud server.

For example, the server 200 in FIG. 1B may be an independent physical server, or may be a server cluster formed by a plurality of physical servers or a distributed system, or may be a cloud server providing basic cloud computing services such as cloud service, a cloud database, cloud computing, a cloud function, cloud storage, a network service, cloud communication, a middleware service, a domain name service, a security service, a content delivery network (CDN), a big data platform, and an artificial intelligence platform. The terminal device 400 and the server 200 may be directly or indirectly connected in a manner of wired or wireless communication, which is not limited in this aspect of this application.

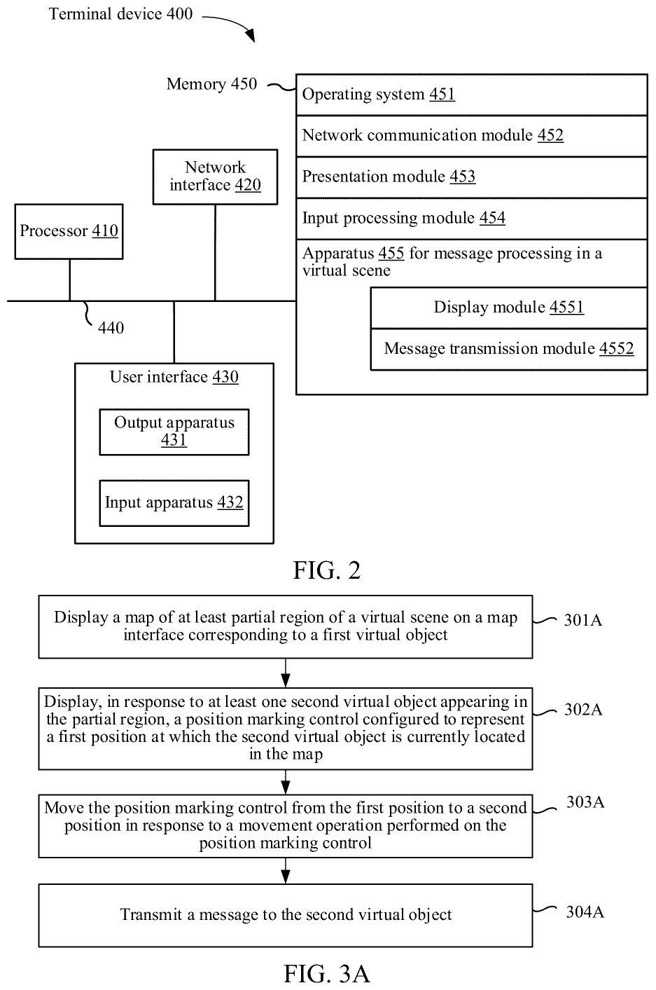

A structure of the terminal device 400 shown in FIG. 1A is described below. FIG. 2 is a schematic structural diagram of a terminal device 400 according to an aspect of this application. The terminal device 400 shown in FIG. 2 includes at least one processor 410, a memory 450, at least one network interface 420, and a user interface 430. Various components in the terminal device 400 are coupled together through a bus system 440. The bus system 440 is configured to implement connection and communication between the components. In addition to a data bus, the bus system 440 further includes a power bus, a control bus, and a status signal bus. However, for clarity, all buses are marked as the bus system 440 in FIG. 2.

The processor 410 may be an integrated circuit chip with a signal processing capability, for example, a general-purpose processor, a digital signal processor (DSP), another programmable logic device, a discrete gate, a transistor logic device, or a discrete hardware component. The general-purpose processor may be a microprocessor, any conventional processor, or the like.

The user interface 430 includes one or more output apparatuses 431 that can present media content, including one or more speakers and/or one or more visual displays. The user interface 430 further includes one or more input apparatuses 432, including user interface components that facilitate user input, such as a keyboard, a mouse, a microphone, a touch display, a camera, and another input button and control.

The memory 450 may be removable, non-removable, or a combination thereof. The memory 450 includes a volatile memory or a non-volatile memory, or may include both the volatile memory and the non-volatile memory. In some aspects, the memory 450 can store data to support various operations. Examples of the data include a program, a module, and a data structure, or a subset or a superset thereof. An exemplary description is provided below.

An operating system 451 includes system programs configured to process basic system services and perform hardware-related tasks, for example, a frame layer, a core library layer, and a driver layer, which are configured to implement basic services and process hardware-based tasks.

A network communication module 452 is configured to reach another computing device through one or more (wired or wireless) network interfaces 420. Exemplary network interfaces 420 include Bluetooth, wireless fidelity (Wi-Fi), and a universal serial bus (USB).

A presentation module 453 is configured to enable presentation of information through one or more output apparatuses 431 (for example, a display and a speaker) associated with the user interface 430 (for example, a user interface configured to operate a peripheral device and display content and information).

An input processing module 454 is configured to detect one or more user inputs or interactions from one of the one or more input apparatuses 432 and translate the detected inputs or interactions.

In some aspects, an apparatus for message processing in a virtual scene provided in one or more aspects of this application may be implemented by software. FIG. 2 shows an apparatus 455 for message processing in a virtual scene stored in the memory 450, which may be software in a form of a program and a plug-in, and includes the following software modules a display module 4551 and a message transmission module 4552. These modules are logical and may be arbitrarily combined in different manners or further split based on to-be-implemented functions.

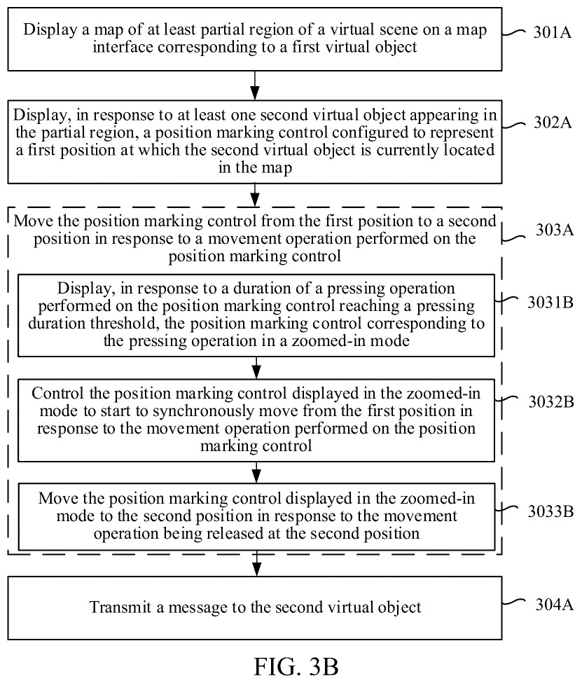

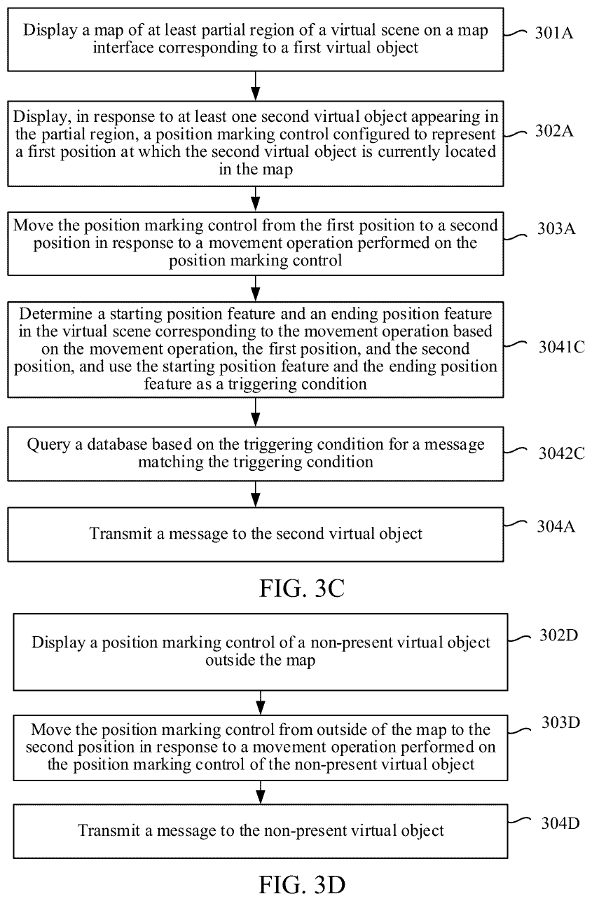

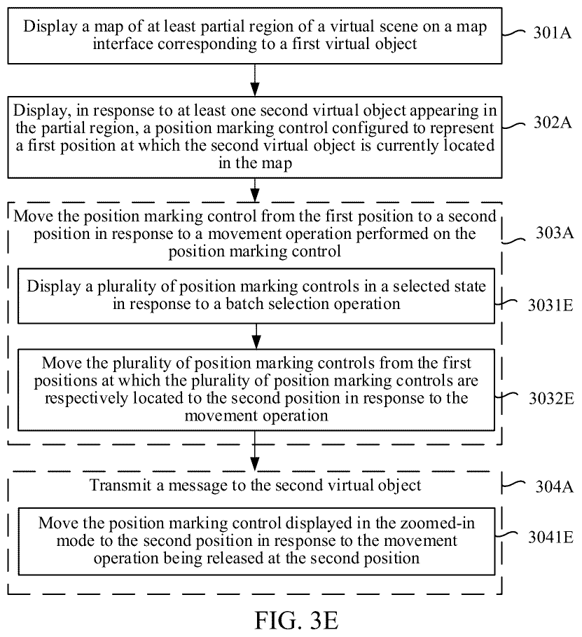

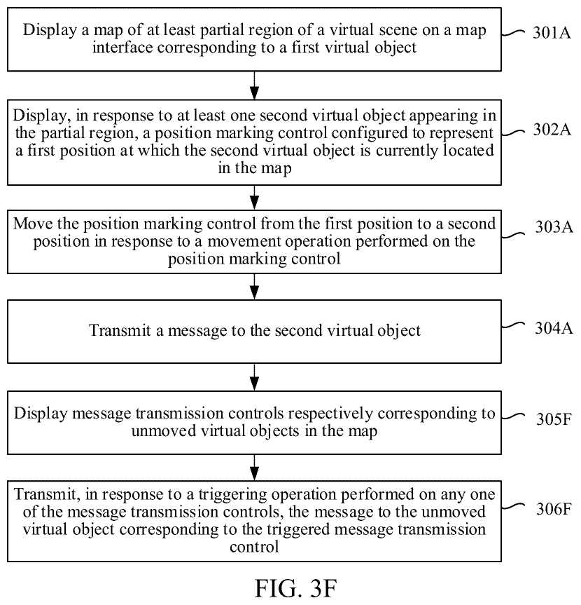

The method for message processing in a virtual scene provided in one or more aspects of this application is described in detail below with reference to the drawings. The method for message processing in a virtual scene provided in one or more aspects of this application may be performed by the terminal device 400 in FIG. 1A. FIG. 3A is a schematic flowchart of a method for message processing in a virtual scene according to an aspect of this application. A description is provided with reference to operations shown in FIG. 3A.

Operation 301A: Display a map of at least partial region of the virtual scene on a map interface corresponding to a first virtual object.

In one example, the map is a preview picture of all regions of the virtual scene, or the map is a preview picture of a partial region of the virtual scene, the partial region being a region radiating outward with the first virtual object as a center. In this aspect of this application, a description is provided by using an example in which the first virtual object is a virtual object corresponding to a user. A second virtual object is another virtual object in the same camp as the first virtual object. The second virtual object may be controlled by another user or artificial intelligence. In this aspect of this application, a description is provided by using an example in which the second virtual object is controlled by the another user. The first virtual object is a virtual object that transmits a message, and the second virtual object is a virtual object that receives the message.

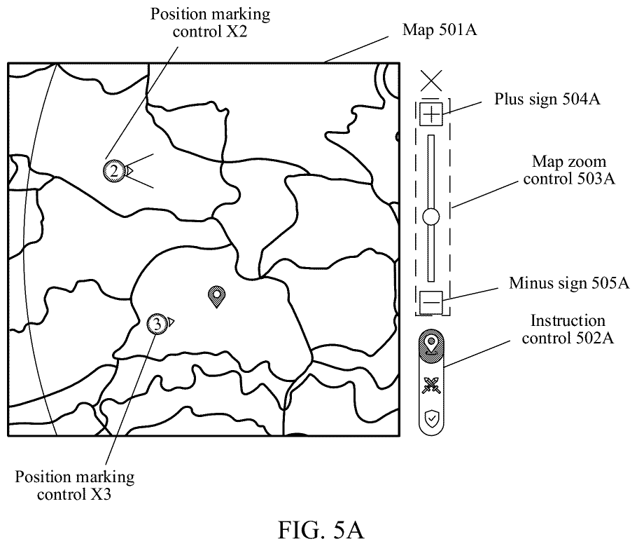

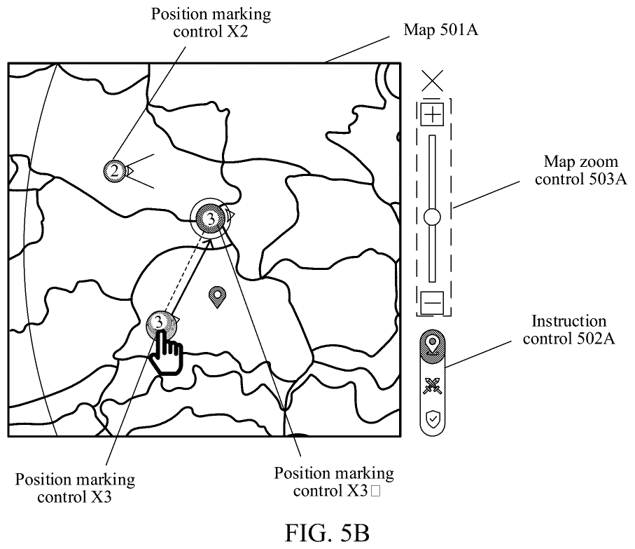

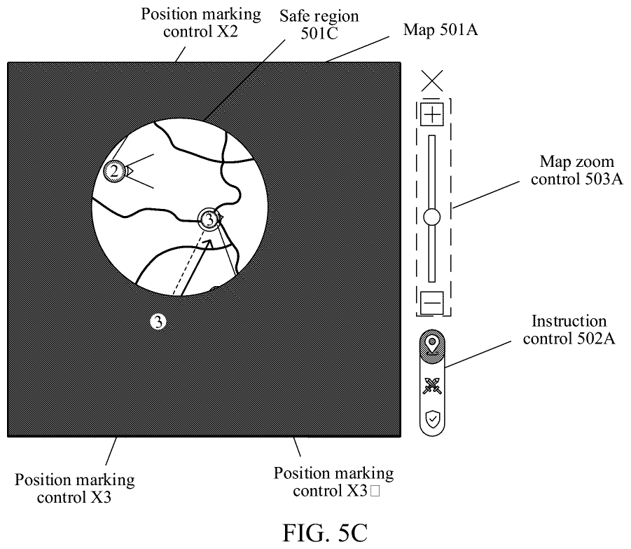

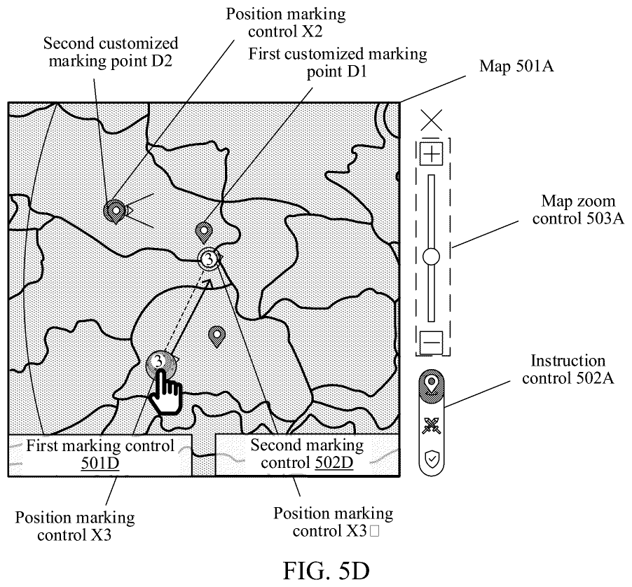

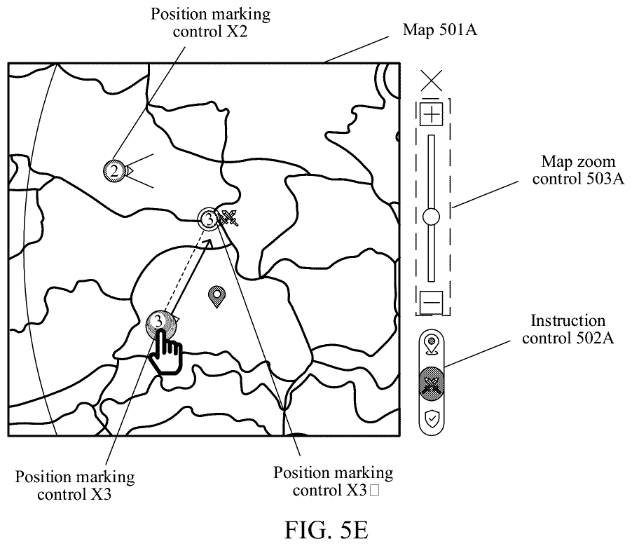

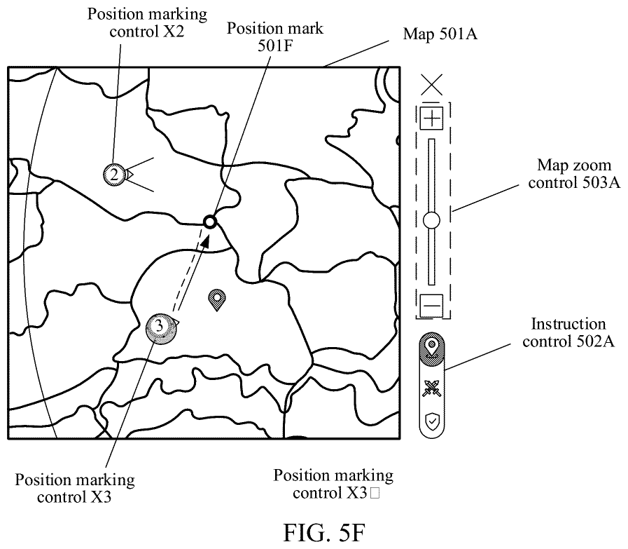

FIG. 5A is a schematic diagram of one example of a map of a method for message processing in a virtual scene according to an aspect of this application. A map 501A is a preview picture of all regions of the virtual scene. A map zoom control 503A is arranged on an edge outside the map 501A. The map zoom control 503A is configured to adjust a ratio between the map and the virtual scene. The map is zoomed in when a circular icon of the map zoom control 503A is moved toward a plus sign 504A, and is zoomed out when the circular icon of the map zoom control is moved toward a minus sign 505A. A position marking control X2 is a position marking control of the first virtual object. The position marking control X2 displays a line segment representing a direction of a field of view of the first virtual object in the virtual scene. A digit 2 represents that the first virtual object is numbered as 2 in a team or a camp. The number is configured for distinguishing between position marking controls of different virtual objects in the same camp. A position marking control X3 corresponds to a second virtual object numbered as 3.

In some aspects, before operation 301A, the map interface may be displayed in any one of the following manners:

1. The virtual scene is displayed on a virtual scene interface, and the map interface is displayed on a floating layer covering a partial region of the virtual scene interface (for example, an upper corner or a lower corner of the interface).

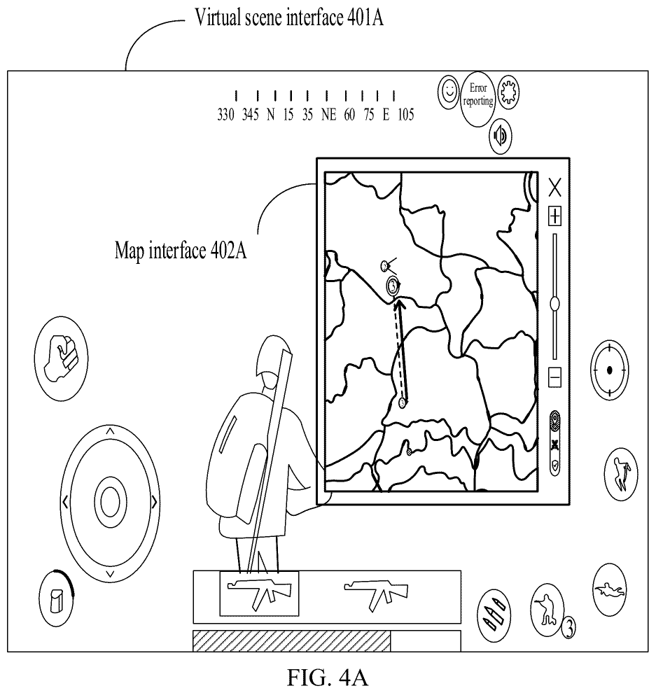

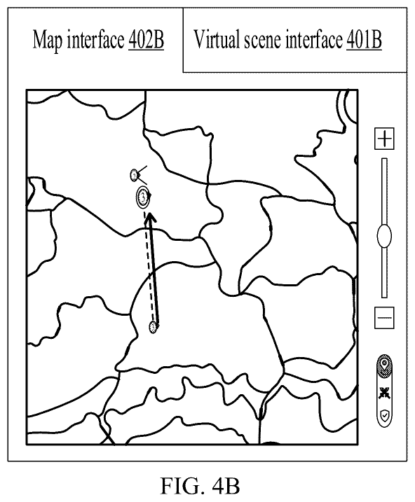

The map interface may be continuously displayed, or may be displayed in response to a call-out operation performed on the map interface, and is hidden in response to a recall operation performed on the map interface. Referring to FIG. 1B or FIG. 1A, the map 102 is continuously displayed at an upper right corner of the virtual scene 101 in the form of the floating layer. FIG. 4A is a schematic diagram of a map interface displayed on a virtual scene interface according to an aspect of this application. On a virtual scene interface 401A, the map interface 402A is displayed on the virtual scene interface 401A in a form of a floating layer in response to a call-out operation performed on a map interface 402A (for example, clicking/tapping a shortcut key corresponding to the map interface).

2. The virtual scene is displayed on the virtual scene interface, and the map interface is displayed in a region outside the virtual scene interface. FIG. 4B is a schematic diagram of a map interface independent of a virtual scene interface according to an aspect of this application. A map interface 402B and a virtual scene interface 401B in FIG. 4B respectively correspond to different label pages. The map interface 402B is displayed independently of the virtual scene interface 401B. A display manner using a label page is merely one of display manners independent of the virtual scene interface. During actual implementation, the map interface 402B may alternatively be displayed independently in another manner.

Operation 302A: Display, in response to at least one second virtual object appearing in the partial region, a position marking control configured to represent a first position at which the second virtual object is currently located in the map.

The second virtual object is any virtual object belonging to the same camp as the first virtual object.

Exemplarily, as the virtual object moves in the virtual scene, the position marking control of the virtual object moves synchronously in the map. In addition to the position marking control of the virtual object, a marking point and a position marking control of a virtual carrier are further displayed in the map. The marking point is a point of a fixed position in the map.

In some aspects, the marking point may be generated in the map in the following manners: causing display of a place marking mode being entered in response to a triggering operation performed on a first marking control in the map, and causing display of a first customized marking point at a clicking/tapping position on the map in response to a clicking/tapping operation performed on the map; and causing display of a second customized marking point at the first position in the map at which the first virtual object is currently located in response to a triggering operation performed on a second marking control in the map.

The first customized marking point is configured to be synchronously displayed on a map interface corresponding to the second virtual object. The second customized marking point is configured to be synchronously displayed on the map interface corresponding to the second virtual object.

The place marking mode may be displayed in any one of the following manners: a text prompt, switching of a background color of the map to another color, and highlighting of a grid line in the map used as a position reference.

In this aspect of this application, the customized marking point is synchronously displayed on the map interface of the second virtual object, which achieves sharing of position information corresponding to the marking point among teammates, and facilitates team cooperation among teammates in the same camp based on different position marks. In addition, the marking point may serve as a reference point for different positions on the map, so that a user may drag the position marking control to a required position based on the reference point, thereby improving accuracy of a second position carried in the message.

FIG. 5D is a schematic diagram of an example of a map of a method for message processing in a virtual scene according to an aspect of this application. In a map 501A, a first marking control 501D and a second marking control 502D are displayed on an edge inside the map. The first marking control 501D may be triggered to enter the place marking mode (referring to FIG. 5A and FIG. 5D, the map 501A in FIG. 5D is displayed in a color different from that of the map 501A in FIG. 5A). In the place marking mode, in response to a clicking/tapping operation performed on any position on the map, the first customized marking point, for example, a first customized marking point D1 is displayed at the clicking/tapping position on the map. When the second marking control 502D is triggered, a second customized marking point D2 is displayed at a position at which the position marking control X2 of the first virtual object is located.

In this aspect of this application, the second virtual object is a teammate of the first virtual object. The customized marking point is configured to be synchronously displayed on the map interface corresponding to the second virtual object. In other words, a customized marking point marked by the user on an own map is shared to maps of other teammates, and each user in the same team can view the customized marking point on the respective maps, which achieves sharing of the marking point, and improves interaction efficiency.

In some aspects, the position marking control corresponding to the virtual carrier may be displayed in the following manner: causing display of, in response to at least one virtual carrier (such as a car, a motorcycle, and an aircraft) appearing in the partial region, a position marking control in the map configured to represent that the virtual carrier is at the second position, a mark type of the position marking control of the virtual carrier being a virtual carrier position mark.

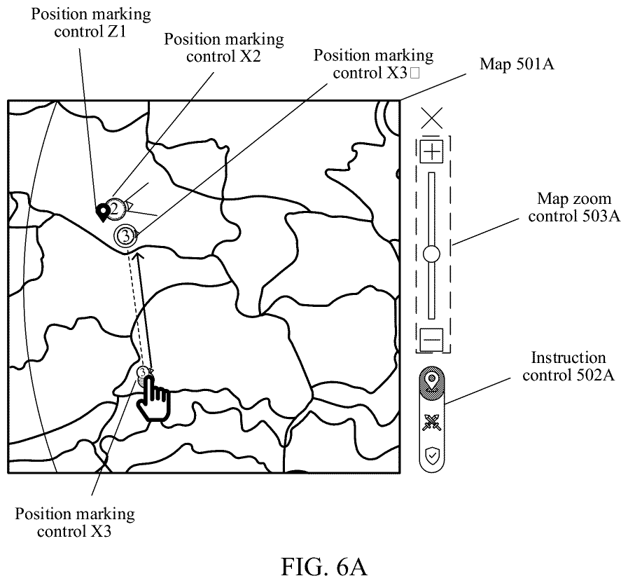

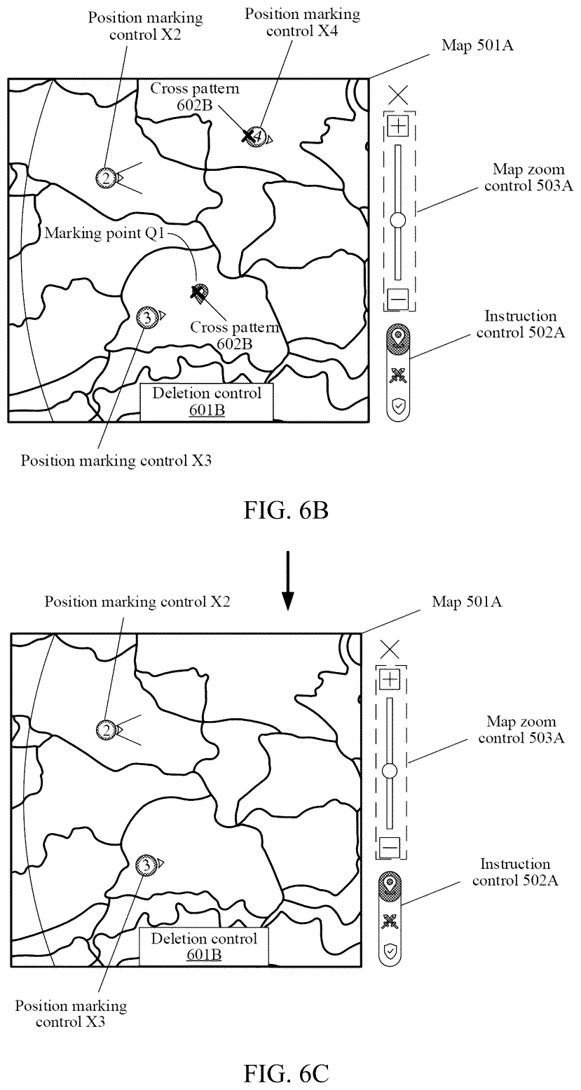

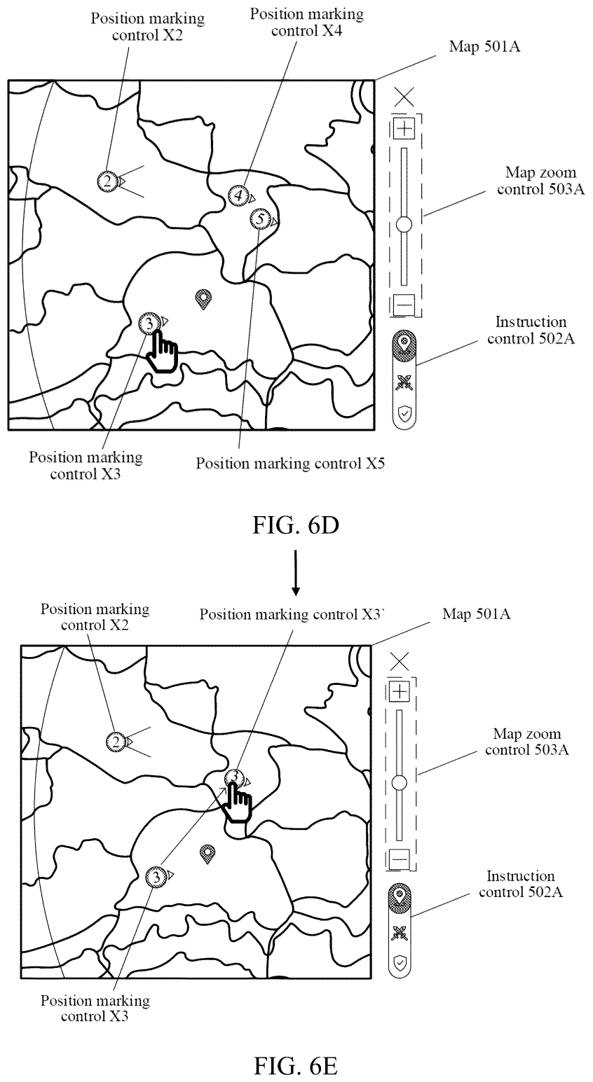

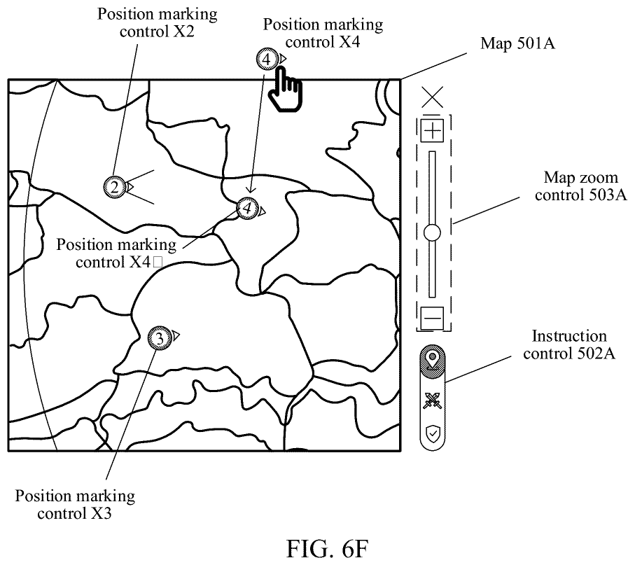

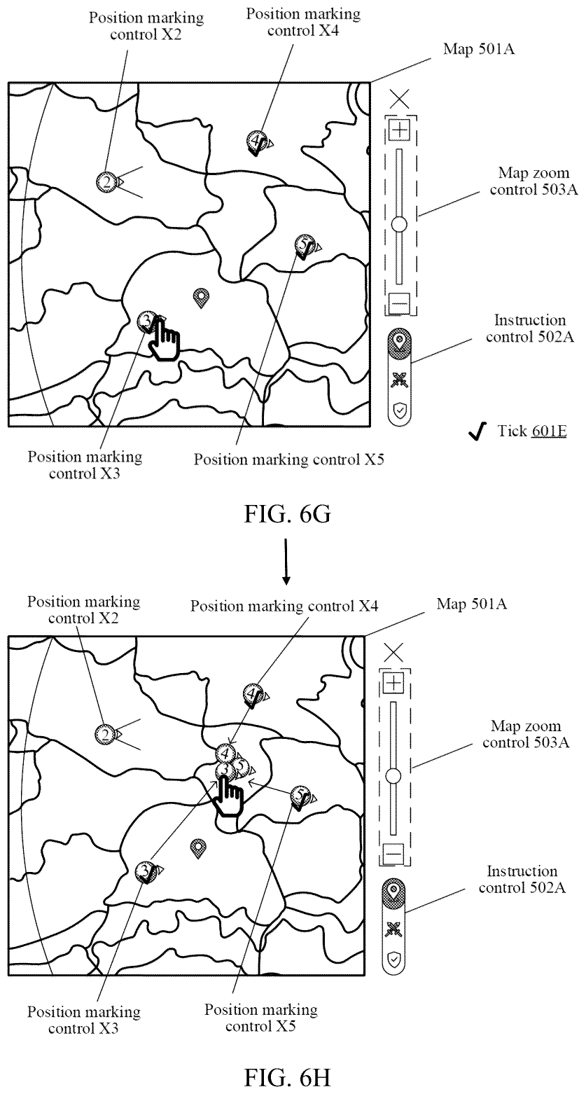

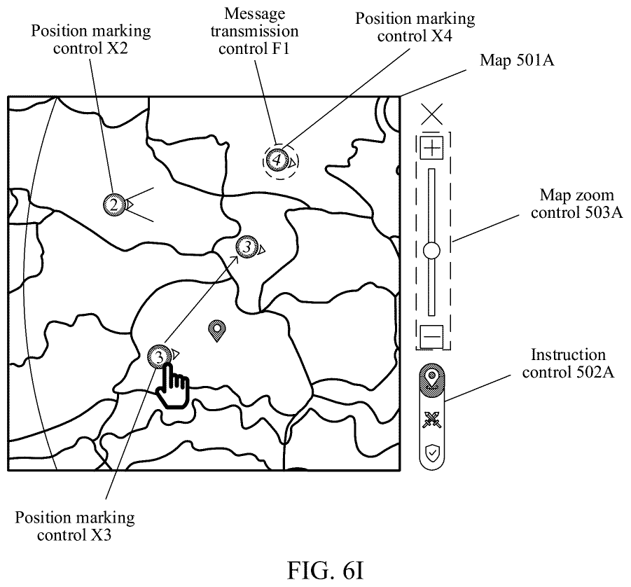

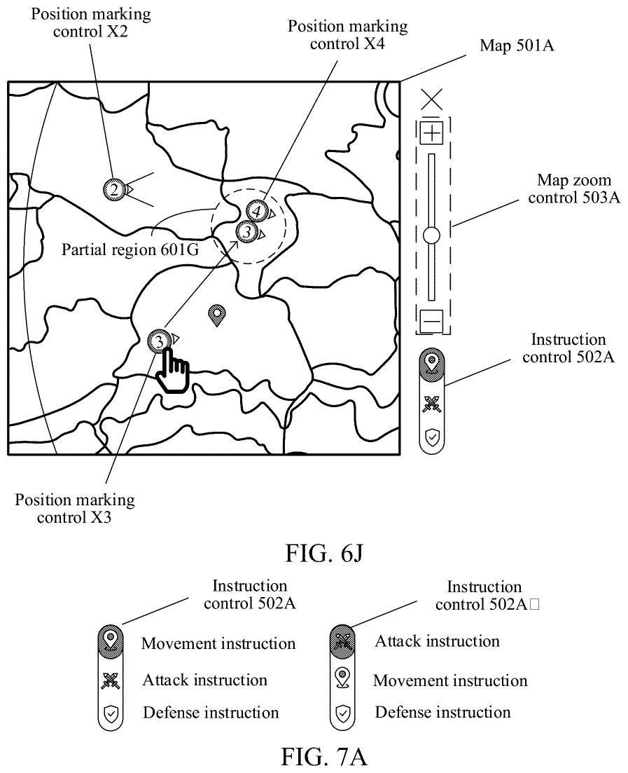

Exemplarily, the virtual carrier is a prop in the virtual scene configured to carry the virtual object. In response to a driving operation performed on the virtual carrier, a picture showing the virtual carrier carrying the virtual object and moving is displayed in the virtual scene. The position marking control of the virtual carrier in the map moves with a change of a position of the virtual carrier in the virtual scene. FIG. 6A is a schematic diagram of a map of a method for message processing in a virtual scene according to an aspect of this application. A position marking control Z1 of the virtual carrier is displayed at a position adjacent to the position marking control X2 of the first virtual object. If the first virtual object drives the virtual carrier corresponding to the position marking control Z1, the position marking control Z1 and the position marking control X2 are displayed in an overlaying manner, and the position marking control X2 and the position marking control Z1 move synchronously.

Operation 303A: Move the position marking control from the first position to a second position in response to a movement operation performed on the position marking control.

In some aspects, FIG. 3B is a schematic flowchart of a method for message processing in a virtual scene according to an aspect of this application. Operation 303A may be implemented through operation 3031B to operation 3033B. Details are described below.

Operation 3031B: Display, in response to a duration of a pressing operation performed on the position marking control reaching a pressing duration threshold, the position marking control corresponding to the pressing operation in a zoomed-in mode.

Exemplarily, the zoomed-in mode means that the position marking control is displayed in a size that is a preset multiple of an original size. The preset multiple is greater than 1, for example, is 1.2. FIG. 5B is a schematic diagram of a map of a method for message processing in a virtual scene according to an aspect of this application. A position marking control X3 in FIG. 5B is displayed in the zoomed-in mode, which is larger than the position marking control X3 displayed in an original size in FIG. 5A. A hand pattern represents a pressing operation performed on the position marking control X3. The pressing duration threshold may be 0.5 seconds or a duration less than 0.5 seconds. When a duration of the pressing operation reaches the pressing duration threshold, the position marking control X3 is displayed in the zoomed-in mode, and the position marking control X3 may be moved.

Operation 3032B: Control the position marking control displayed in the zoomed-in mode to start to synchronously move from the first position in response to the movement operation performed on the position marking control.

Exemplarily, the first position is a starting position of the movement operation. The synchronous movement means that the position marking control X3 is controlled to be synchronously displayed at a pressing position on the map corresponding to the movement operation during the movement operation in response to the user continuously pressing the position marking control X3. Still referring to FIG. 5B, a position marking control X3′ represents the position marking control X3 after being moved. A direction of an arrow between the two represents a direction of the movement operation, and dashed lines represent a movement trajectory of the position marking control X3.

Operation 3033B: Move the position marking control displayed in the zoomed-in mode to the second position in response to the movement operation being released at the second position.

For example, the movement operation being released at the second position means that the user lifts a finger to stop pressing the map when the finger moves to the second position. The second position is an ending position of the movement operation. Still referring to FIG. 5B, the second position at which the position marking control X3′ is located in the map 501A is the ending position of the movement operation.

In some aspects, when a plurality of position marking controls are displayed in the map, an excessive position marking control may be deleted in the following manner: causing display of, in response to a selection operation performed on any one of the position marking controls, the selected position marking control in a selected state (for example, an inverted color, highlighting, tick annotation, or cross annotation); and deleting the position marking control in the selected state in response to a deletion operation performed on the position marking control in the selected state.

For example, when position marking controls of a plurality of second virtual objects are displayed, some of the position marking controls of the second virtual object may be deleted. To be specific, only the position marking controls of the second virtual objects to which the message is transmitted are retained. The deletion means that the position marking controls of the second virtual objects are hidden or shielded in the map or displayed in a blurred manner.

FIGS. 6B and 6C are schematic diagrams of maps used in a method for message processing in a virtual scene according to an aspect of this application. In FIG. 6B, the map 501A includes a marking point Q1, a position marking control X4 (representing a second virtual object numbered as 4), and a deletion control 601B. A cross pattern 602B is displayed on each of the selected marking point Q1 and the selected position marking control X4 to indicate the selected state. In response to the deletion control 601B being triggered, the marking point Q1 and the position marking control X4 in the selected state are deleted. FIG. 6C shows a map 501A with the marking point Q1 and the position marking control X4 being deleted.

In some aspects, the position marking control may be automatically deleted in the following manner: hiding the position marking control of each second virtual object that is not moved in response to a movement operation performed on any position marking control.

FIGS. 6D-6E are schematic diagrams of maps of a method for message processing in a virtual scene according to an aspect of this application. In FIG. 6D, a pressing operation is applied to the position marking control X3. The map 501A includes a position marking control X5 (representing a second virtual object numbered as 5) and a position marking control X4. In FIG. 6E, during movement of the position marking control X3, the position marking control X5 and the position marking control X4 that are not moved are hidden. Exemplarily, if the movement operation performed on the position marking control X3 is released, the hidden position marking control X5 and the position marking control X4 are recovered.

In this aspect of this application, through deletion of some of the position marking controls, shielding of the map caused by excessive position marking controls is avoided, resources consumed by graphics computing are reduced, and the user can conveniently perform observation and operations on the map to move the position marking control of the second virtual object receiving the message to a position required by the user, thereby improving human-computer interaction efficiency.

Operation 304A: Transmit the message to the second virtual object.

The message is configured for instructing the second virtual object to arrive at the second position and executed the instruction. The message carries the second position and the instruction. The message is a point-to-point message.

In one example, operation 303A and operation 304A are performed simultaneously. Message types include a voice message, a text message, and a mixture of the voice message and the text message.

In some aspects, the message may be transmitted to the second virtual object in any one of the following manners:

1. A message type selection control is displayed in response to the movement operation performed on the position marking control being released, and the message is transmitted to the second virtual object based on a selected message type in response to a selection operation performed on the message type selection control. The message type selection control includes the following message types: a voice message, a text message, and a mixture of the voice message and the text message. The mixture of the voice message and the text message is presented in the following manner: causing display of a text of the message on a human-computer interaction interface of the second virtual object, and playing the text message and a corresponding voice to the second virtual object.

2. The message is transmitted to the second virtual object based on a set message type in response to the movement operation performed on the position marking control being released.

In some aspects, manners of instructing the second virtual object through the message include the following:

1. Content of the message is displayed to the second virtual object in a form of a voice or a text, the content of the message including the instruction and the second position. For example, text content of the text message is “Go to the building B (1234, 5678)”, “Building B (1234, 5678)” is the second position, “Go” represents a movement instruction, and (1234, 5678) is position coordinates of the building B on the map.

2. Content of the message including the instruction is displayed to the second virtual object in the form of a voice or a text, and at least one of the following is displayed on the map interface corresponding to the second virtual object: a position mark of the second position, a direction of the second position relative to the position marking control of the second virtual object, and a path between the position marking control of the second virtual object and the second position. In the manner, the voice message or the text message may not include the second position.

For example, the text content of the text message is “Attack the enemy”, and the path between the second virtual object and the second position at which a rival virtual object is located is displayed on the map interface corresponding to the second virtual object. The text content does not include a clear second position, but the second position is indicated to the second virtual object through display of the path.

3. Content of the message is displayed to the second virtual object in a form of a voice or a text, the content of the message including the instruction and the second position. In addition, at least one of the following is displayed on the map interface corresponding to the second virtual object: a position mark of the second position, a direction of the second position relative to the position marking control of the second virtual object, and a path between the position marking control of the second virtual object and the second position.

For example, the content of the message is “Attack the enemy on the plain (3216, 4578)”, and the path between the second virtual object and the second position at which a rival virtual object is located is displayed on the map interface corresponding to the second virtual object. (3216, 4578) is position coordinates of the second position, and “on the plain” is a description of the second position.

In some aspects, the second position may be displayed in the following manner: causing display of the position marking control or the position mark prominently (for example, through highlighting, circling with an annotation block, causing display of in another color, causing display of in a bold form, or displaying by flashing) when a position marking control or a position mark exists at the second position; and causing display of a position mark at the second position when the position marking control or the position mark does not exist at the second position.

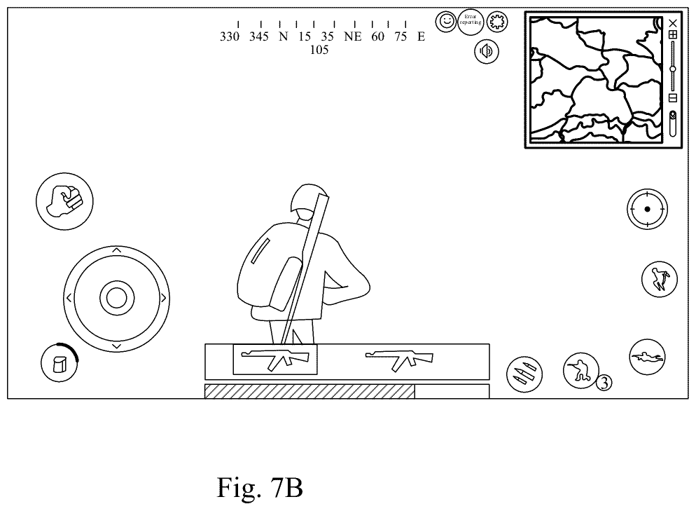

A process of instructing the second virtual object through the message based on the above manner 2 is described below by using an example. FIG. 7B is a schematic diagram of a virtual scene interface corresponding to a second virtual object according to an aspect of this application. A map 702 is displayed at an upper right corner of a virtual scene 701. A picture related to the movement operation in the map corresponding to the first virtual object is synchronously displayed in the map 702 of the second virtual object, so that the message is more prominent, which facilitates timely response of a user corresponding to the second virtual object. In the virtual scene 701, text content 703 “Gather with the teammate 2” of the message, i.e., gather with the virtual object corresponding to the user transmitting the message, is displayed. The teammate 2 is the first virtual object. The direction and the path between the position marking control of the second virtual object and the second position are shown in the map 702.

In some aspects, before operation 303, the instruction carried in the message may be determined in the following manner: causing display of an instruction control inside or outside the map, the instruction control including a plurality of types of candidate instructions; and causing display of, in response to an instruction selection operation performed (which may be performed before or after the movement operation) on any one of the candidate instructions of the instruction control, the selected candidate instruction in a selected state, and using the selected candidate instruction as the instruction carried in the message.

Referring to FIG. 5A, an instruction control 502A is displayed outside the map 501A. FIG. 7A is a schematic diagram of an arrangement of an instruction control according to an aspect of this application. Instruction types corresponding to the instruction control 502A include an attack instruction, a defense instruction, and a movement instruction. A dark portion represents that the candidate instruction is in the selected state. The selected state may alternatively be displayed through highlighting, a bold form, tick annotation, or the like.

In some aspects, for the selected state, in response to the instruction selection operation performed on any one of the candidate instructions of the instruction control, the selected candidate instruction is maintained in the selected state before a next instruction selection operation is received. Alternatively, after the point-to-point message is transmitted to the second virtual object, switching from displaying the selected candidate instruction in the selected state to displaying a default instruction in the selected state is performed.

The default instruction is a candidate instruction of the plurality of types of candidate instructions set to be in an automatically selected state.

Exemplarily, the default instruction may be a first instruction at a top of usage probabilities corresponding to all of the candidate instructions ranked in the descending order. For example, the movement instruction is frequently used in the virtual scene. The movement instruction is used as the default instruction. For example, the default instruction is the movement instruction. When the user selects the attack instruction and transmits the message, the attack instruction in the selected state is switched to a non-selected state, and the movement instruction is switched to the selected state. For another example, if the user selects the movement instruction, the movement instruction is maintained in the selected state before the next instruction selection operation is received.

In this aspect of this application, through automatic maintaining of the candidate instruction in the instruction control in the selected state or switching of the default instruction to the selected state, repeated operations performed by the user on the instruction control are avoided, message transmission time is reduced, and computing resources are saved.

In some aspects, before operation 303, the instruction carried in the message may be determined in the following manner: causing display of an instruction control inside or outside the map, the instruction control including a plurality of types of candidate instructions, and one of the plurality of types of candidate instructions being in an automatically selected state; and using the candidate instruction in the automatically selected state as the instruction carried in the message in response to an instruction selection operation performed on any one of the candidate instructions of the instruction control being not received within a set duration.

For example, the set duration may be 5 minutes. Assuming that the movement instruction in the instruction control is in the automatically selected state, if no instruction selection operation is received within 5 minutes, the movement instruction in the automatically selected state is used as the instruction carried in the message.

In this aspect of this application, the instruction is in the automatically selected state, so that the instruction carried in the message may be selected for the user without frequent user operations, which reduces message transmission time, and saves computing resources.

In some aspects, when the instruction control includes a plurality of candidate instructions, the plurality of candidate instructions may be ranked in any one of the following manners:

1. The plurality of candidate instructions are ranked in descending order or ascending order based on a usage frequency of each candidate instruction. For example, statistics collection is performed on usage frequencies of candidate instructions of a first virtual object. If a frequency of an attack instruction, a frequency of a movement instruction, and a frequency of a defense instruction are in descending order, the candidate instructions are ranked in descending order based on the frequencies, and the instruction control with the ranking order is displayed on the map of the first virtual object.

2. The plurality of candidate instructions are ranked based on an order in which each candidate instruction is set. For example, an order of the candidate instructions is set by the user as the movement instruction, the attack instruction, and the defense instruction.

3. The plurality of candidate instructions are ranked in ascending order or descending order based on a usage probability of each candidate instruction.

Exemplarily, ranking of the usage probabilities adaptively varies based on a second virtual object dragged each time. In other words, the ranking order varies for different types of second virtual objects. For example, a second virtual object A frequently receives a message carrying the attack instruction. Referring to an instruction control 502A′ in FIG. 7A, in ranking corresponding to the second virtual object A, the attack instruction ranks on the top, and other instructions rank lower. Alternatively, a second virtual object B frequently receives a message carrying the movement instruction. Referring to the instruction control 502A in FIG. 7A, in ranking corresponding to the second virtual object B, the movement instruction ranks on the top.

In this aspect of this application, the instructions are ranked, and instructions frequently used by the user or instructions frequently used for a second virtual object are displayed at a position of a head of the instruction control, so that the user can quickly and conveniently find required instructions, which facilitates efficient message transmission.

In some aspects, the usage probability of each candidate instruction may be determined in following manner: calling a neural network model based on parameters of the virtual objects in the virtual scene to perform prediction, to obtain the usage probability corresponding to each candidate instruction.

The parameters of the virtual object include at least one of a position and an attribute value of the first virtual object, the attribute value including a combat capability, a health point, a defense value, and the like; a position and an attribute value of the second virtual object; and a difference (which may represent power comparison between a rival camp and a partner camp) between an attribute value of a camp to which the first virtual object belongs and an attribute value of a rival camp.

The neural network model is trained based on battle data of at least two camps, the battle data including positions and attribute values of a plurality of virtual objects in the at least two camps, instructions executed by a virtual object of a victorious camp, and instructions executed by a virtual object of a defeated camp, and a label of each instruction executed by the virtual object of the victorious camp being a probability of 1, and a label of each instruction executed by the virtual object of the defeated camp being a probability of 0.

For example, the neural network model may be a graph neural network model or a convolutional neural network model. An initial neural network model is trained based on the battle data, and a prediction probability is calculated based on the battle data through the initial neural network model. A difference between actual probabilities used as labels is substituted into a loss function to calculate a loss value. The loss function may be a mean square error loss function, a mean absolute error loss function, a quantile loss function, a cross entropy loss function, or the like. Back propagation (BP) is performed in the initial neural network model based on the loss value, and parameters of the neural network model are updated by using a BP algorithm, so that the trained neural network model can predict, based on current parameters of the virtual object in the same camp, the usage probability that each candidate instruction is currently used by the first virtual object.

In this aspect of this application, the usage probabilities are obtained through the neural network model, which improves accuracy of obtaining the usage probabilities; and the candidate instructions are ranked based on the usage probabilities, so that the user quickly and conveniently finds required instructions, which facilitates efficient message transmission.

In some aspects, FIG. 3C is a schematic flowchart of a method for message processing in a virtual scene according to an aspect of this application. Before operation 304A, the message to be transmitted to the second virtual object may be determined through operation 3041C to operation 3042C. Details are described below.

Operation 3041C: Determine a starting position feature and an ending position feature in the virtual scene corresponding to the movement operation based on the movement operation, the first position, and the second position, and use the starting position feature and the ending position feature as a triggering condition.

For example, a starting position of the movement operation is the first position, and an ending position of the movement operation is the second position. The position feature may be a region where a position is located, whether a mark exists near the position, or the like.

In some aspects, operation 3041C may be implemented in the following manner: determining a first region (for example, an unsafe region or a safe region) in which the first position is located in the virtual scene and a second region (for example, an unsafe region or a safe region) in which the second position is located in the virtual scene; determining a mark type on the map interface corresponding to the second position, the mark type including no mark, a virtual object position mark, and a virtual carrier position mark; and using the first region as the starting position feature of the movement operation, and using the second region and the mark type as the ending position feature of the movement operation.

For example, in the unsafe region, the health point of the virtual object periodically decreases. On the contrary, the safe region is a region in the virtual scene in which the health point of the virtual object does not enter a periodically decreasing state. FIG. 5C is a schematic diagram of a map of a method for message processing in a virtual scene according to an aspect of this application. The first position corresponding to the position marking control X3 is in a safe region 501C, and the ending position of the movement operation is within the safe region 501C (at a position of the position marking control X3′). A mark type of the ending position is no mark.

In some aspects, the mark type on the map interface corresponding to the second position may be determined in the following manner: A partial region of the map with the second position as a center is detected. For example, FIG. 6J is a schematic diagram of a map of a method for message processing in a virtual scene according to an aspect of this application. A partial region 601G may be a circular region with the second position as a center. A radius R of the circular region is positively correlated with a misoperation identification precision. When at least one position marking control is detected, a mark type corresponding to a detected position marking control closest to the second position is used as the mark type on the map interface corresponding to the second position. When the position marking control is not detected, no mark is used as the mark type on the map interface corresponding to the second position.

Still referring to FIG. 6J, when the position marking control X4 exists in the partial region, the mark type on the map interface corresponding to the second position is the virtual object position mark.

Operation 3042C: Query a database based on the triggering condition for a message matching the triggering condition.

The database may have correspondences between different messages and different triggering conditions stored therein.

In some aspects, when a type of the instruction is the movement instruction and the virtual carrier exists within a preset range around the second position, the content of the message is to gather at the second position and enter the virtual carrier. In this aspect of this application, a description is provided by using an example in which the virtual carrier is a drivable vehicle. Still referring to FIG. 6A, the position marking control Z1 of the virtual carrier is displayed near the position marking control X2 of the first virtual object. The movement operation causes the position marking control X3 to move to the position marking control X2, and the message content may be “Gather with the teammate 2 and board”.

In some aspects, when the type of the instruction is the movement instruction and the virtual carrier does not exist at the second position, the content of the message is to gather at the second position. Still referring to FIG. 5B, when the virtual carrier does not exist at the second position of the movement operation, the content of the message may be “Move to xxx (a specified place)”.

In some aspects, when the type of the instruction is the attack instruction and the virtual carrier exists at the second position, the content of the message is to go to the second position and perform attack. FIG. 5E is a schematic diagram of a map of a method for message processing in a virtual scene according to an aspect of this application. A current instruction of the instruction control 502A in the selected state is the attack instruction. In this case, after the position marking control X3 is moved to the second position, a small icon of the attack instruction may be displayed near the position marking control X3′ obtained after the movement. The small icon of the attack instruction is synchronously displayed on the map of the second virtual object, so that the second virtual object determines a to-be-attacked position. The message content may be “Attack xxx (a specified position)”.

In some aspects, when the type of the instruction is the defense instruction, the content of the message is to go to the second position and perform defense. A manner of processing the defense instruction is the same as that of the attack instruction, and therefore details are not described herein. The corresponding message content may be “Defend xxx (a specified position)”.

In some aspects, when the map of the partial region of the virtual scene is displayed on the map interface, FIG. 3D is a schematic flowchart of a method for message processing in a virtual scene according to an aspect of this application. The message may be transmitted to the second virtual object outside the map through operation 302D to operation 304D. Details are described below.

Operation 302D: Display a position marking control of a non-present virtual object outside the map.

The non-present virtual object is a second virtual object that currently does not appear in the partial region.

For example, FIG. 6F is a schematic diagram of a map of a method for message processing in a virtual scene according to an aspect of this application. The position marking control X4 is a second virtual object that is numbered as 4 and located outside a range of the virtual scene corresponding to the map. The position marking control X4 is displayed on an upper edge outside the map 501A.

Operation 303D: Move the position marking control from outside of the map to the second position in response to a movement operation performed on the position marking control of the non-present virtual object.

Exemplarily, the movement operation in operation 303D is the same as that in operation 303A. Details are not described herein.

Still referring to FIG. 6F, a hand pattern represents the movement operation. In response to the movement operation, the position marking control X4 is moved from the outside of the map 501A to the second position (a position at which a position marking control X4′ is located) inside the map 501A. The position marking control X4′ is configured to represent the position marking control X4 after the movement.

Operation 304D: Transmit a message to the non-present virtual object.

The message carries the second position and an instruction. The message is a point-to-point message.

In one example, operation 303D and operation 304D are performed simultaneously. For a manner of determining content of the message in operation 304D, reference may be made to the above operation 3041C to operation 3042C. A manner of transmitting the message in operation 304D is the same as that in operation 304A. Details are not described herein.

In this aspect of this application, the position marking control of the virtual object that does not appear on the map is displayed outside the map, and the message is transmitted to the virtual object outside the map through the movement operation, so that efficient message transmission is achieved for all virtual objects in the camp in the entire virtual scene, the map interface is reused, and relevant computing resources for rendering the virtual scene by terminal are saved.

In some aspects, FIG. 3E is a schematic flowchart of a method for message processing in a virtual scene according to an aspect of this application. When position marking controls configured to represent first positions at which a plurality of second virtual objects are currently located are displayed in the map, operation 303A may be achieved through operation 3031E and operation 3032E, and operation 304A may be achieved through operation 3041E. Details are described below.

Operation 3031E: Display a plurality of position marking controls in a selected state in response to a batch selection operation.

Exemplarily, the selected state may be represented in a form such as highlighting, a bold form, or tick annotation. FIGS. 6G-6H is are schematic diagrams of maps of a method for message processing in a virtual scene according to an aspect of this application. In FIG. 6G, the position marking control X3, the position marking control X4, and position marking control X5 each are annotated with a tick 601E. The above three position marking controls are selected in batch and displayed in the selected state.

Operation 3032E: Move the plurality of position marking controls from the first positions at which the plurality of position marking controls are respectively located to the second position in response to the movement operation.

Exemplarily, the movement operation is performed for any one of the plurality of selected position marking controls. Still referring to FIG. 6G, a hand pattern presses the position marking control X3, and the movement operation actions on only the position marking control X3. The position marking control X3 moves along a movement trajectory of the movement operation on the map. When the movement operation is released at the second position, each position marking control in the selected state that does not move with the movement operation moves from the first position corresponding to each position marking control to the second position. In FIG. 6H, the hand pattern remains at the second position. In other words, the movement operation is released at the second position. The position marking control X4 and the position marking control X5 are moved to the second position.

Operation 3041E: Transmit a message to the second virtual objects respectively corresponding to the plurality of position marking controls.

The message carries the second position and an instruction. Each second virtual object receives the same second position and instruction.

Exemplarily, operation 3032E and operation 3041E are performed simultaneously. A manner of transmitting the message in operation 3041E is the same as that in the above operation 304A. Details are not described herein.

In this aspect of this application, through batch selection of the position marking controls, reuse of the map and batch point-to-point message transmission for a plurality of teammate virtual objects are achieved, message transmission efficiency is improved, interference with teammates irrelevant to the message is avoided, occupation of an internal running memory of clients of the teammates irrelevant to the message is avoided, high resource consumption caused by high concurrency of messages is avoided, and computing resources required for message transmission are saved.

In some aspects, FIG. 3F is a schematic flowchart of a method for message processing in a virtual scene according to an aspect of this application. After operation 304, the message may be transmitted to an unmoved virtual object through operation 305F to operation 306F. Details are described below.

Operation 305F: Display message transmission controls respectively corresponding to unmoved virtual objects in the map.

The unmoved virtual objects are second virtual objects to which the message is not transmitted, and the message transmission controls are configured to repeatedly transmit the message.

For example, FIG. 6I is a schematic diagram of a map of a method for message processing in a virtual scene according to an aspect of this application. The position marking control X3 is moved to the second position. When the second virtual object numbered as 3 corresponding to the position marking control X3 receives the corresponding message, the position marking control X3 is displayed at a position at which the second virtual object numbered as 3 is currently located. During the movement of position marking control X3, if the position marking control X4 is not moved, the second virtual object corresponding to the position marking control X4 is the unmoved object, and a message transmission control F1 is displayed near the position marking control X4. The message transmission control F1 is configured to repeatedly transmit a previously transmitted message.

Operation 306F: Transmit, in response to a triggering operation performed on any one of the message transmission controls, the message to the unmoved virtual object corresponding to the triggered message transmission control.

Exemplarily, a description is provided still with reference to FIG. 6I. It is assumed that the message received by the second virtual object corresponding to the position marking control X3 is “Gather at xxx (a specified position)”. When the message transmission control F1 corresponding to the position marking control X4 is triggered, the second virtual object corresponding to the position marking control X4 also receives the message “Gather at xxx (a specified position)”.

In this aspect of this application, the previously transmitted message is repeatedly transmitted through the arranged message transmission control, so that the same message can be transmitted without requiring the user to remove the position marking control in the map to an ending position the same as that of a previous movement operation, which reduces operation time required for message transmission.

In one or more aspects of this application, the position marking control of the second virtual object in the same camp as the first virtual object is displayed on the map interface, and when the position marking control of the second virtual object is moved, the corresponding instruction and message are transmitted to the second virtual object based on the movement operation, which achieves shortcut transmission of the point-to-point message by using the map interface of the virtual scene without a need of voice transmission or text input. Instead, merely dragging the position marking control can achieve shortcut message transmission, thereby reducing time required for message transmission. In addition, through message transmission to only the second virtual object, precise point-to-point message transmission is achieved, and interference with other virtual objects in the same camp is avoided. Moreover, the position marking control on the map interface of the virtual scene is reused without a need to arrange a new control configured to transmit a message on a human-computer interaction interface, and point-to-point message transmission can be achieved without a need to use a radio device (for example, a microphone), thereby reducing computing resources required for the virtual scene.

An exemplary application of one or more aspects of this application in a multiplayer competition game is described below. The multiplayer competition game provided by the relevant art includes communication manners such as voice communication, shortcut messages preset in a game system, and text input. However, the voice communication is limited by a radio device and a playback device, and some players may not be equipped with a radio device such as a microphone, or may not be equipped with a playback device such as a headset. Some players that are unwilling to display real voices in the game may choose to communicate through text, but the text input is time-consuming. The shortcut messages preset in the game system are limited and therefore cannot fully express information a player wants to convey. Messages visible or audible to an entire team may cause interference to some teammates (on the one hand, high concurrency of messages visible or audible to the entire team occurs, and the teammates are likely to fail to extract a valid message, and on the other hand, the messages visible to the entire team cause a waste of computing resources and occupy an internal running memory of a client of the teammates), and these communication manners cannot achieve separate communication for a teammate. In the method for message processing in a virtual scene provided in one or more aspects of this application, the map of the virtual scene is reused, and the point-to-point message can be quickly and conveniently transmitted to a teammate through movement of a position marking control (for example, a teammate icon control) corresponding to the teammate on the map, which improves message transmission efficiency with low computing resource consumption.

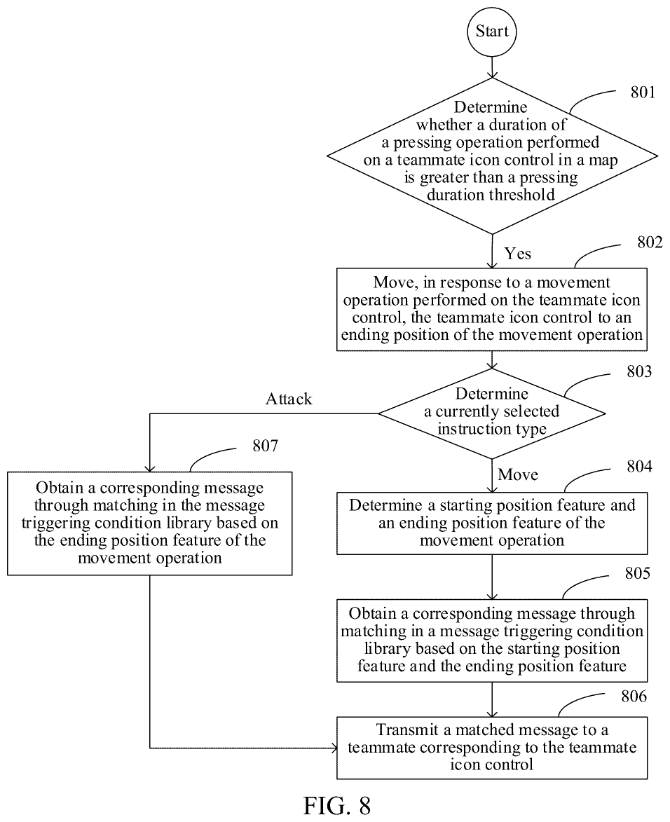

A description is provided below by using an example in which the method for message processing in a virtual scene provided in one or more aspects of this application is collaboratively performed by the terminal device 400 and the server 200 in FIG. 1B. FIG. 8 is a schematic flowchart of a method for message processing in a virtual scene according to an aspect of this application. A description is provided with reference to operations shown in FIG. 8.

Operation 801: Determine whether a duration of a pressing operation performed on a teammate icon control in a map is greater than a pressing duration threshold.

Exemplarily, the map is a virtual map corresponding to the virtual scene. A coordinate system is bound to the virtual map. Coordinates of each position in the virtual scene are fixed in the virtual map. The teammate icon control is a position marking control in the map configured to represent a second virtual object in the same team (or the same camp) as a first virtual object corresponding to a user. The teammate icon control is an operable position marking control (on which, for example, a movement operation or a pressing operation may be performed).

A description is provided below with reference to the drawings. As discussed above and referring back to FIG. 5A, FIG. 5A is a schematic diagram of a map of a method for message processing in a virtual scene according to an aspect of this application. In a map 501A, a position marking control X2 is a position marking control of the first virtual object. A digit 2 represents that the first virtual object is numbered as 2 in the team or the camp. A position marking control X3 corresponds to a second virtual object numbered as 3. A map zoom control 503A and an instruction control 502A are arranged on an edge outside the map 501A. The map zoom control 503A is configured to adjust a ratio between the map and the virtual scene. The map is zoomed in when a circular icon of the map zoom control 503A is moved toward a plus sign 504A, and is zoomed out when the circular icon of the map zoom control is moved toward a minus sign 505A. The instruction control 502A is configured to switch a type of an instruction carried in a message transmitted to a teammate.

In one example, the pressing duration threshold may be 0.5 seconds. When the user presses the teammate icon control for 0.5 seconds, it is determined that an icon triggering operation is received, and the teammate icon control may move on the map based on a movement operation. In response to the icon triggering operation, the teammate icon control is displayed in a zoomed-in mode, and the teammate icon control moves with the movement operation (to be specific, the pressing operation is maintained, and the pressed position is slid or dragged on a human-computer interaction interface). As discussed above, FIG. 5B is a schematic diagram of a map of a method for message processing in a virtual scene according to an aspect of this application. The position marking control X3 is displayed in the zoomed-in mode, which is larger than the position marking control X3 in FIG. 5A.

Exemplarily, in this aspect of this application, the teammate icon control is displayed in the zoomed-in mode, so that the controlled position marking control is more prominent, thereby facilitating an operation of the user, and improving interaction efficiency.

Operation 802: Move, in response to a movement operation performed on the teammate icon control, the teammate icon control to an ending position of the movement operation.

Exemplarily, the movement operation may be a continuous dragging operation or a sliding operation.

As discussed above and referring to FIG. 5B, a hand pattern represents a pressing operation performed by a finger of the user on the position marking control X3. When the user maintains the pressing operation on the position marking control X3 for a duration greater than 0.5 seconds, the position marking control X3 may be moved, and the finger is moved from a first position at which the position marking control X3 is currently located to a second position in a direction of an arrow. The position marking control X3 moves with a position of the movement operation on the human-computer interaction interface. When the movement operation is stopped or released, the stopped or released position is used as the ending position of the movement operation, i.e., the second position. A position marking control X3′ at the second position is a position marking control obtained after movement. Before a message for the second virtual object is transmitted, the position marking control X3′ is temporarily displayed at the second position. When the transmission of the message is completed, the position marking control at the second virtual object is returned to a current position corresponding to the second virtual object in the map.

Operation 803: Determine a currently selected instruction type.

FIG. 7A is a schematic diagram of an arrangement of an instruction control according to an aspect of this application. Instruction types corresponding to the instruction control 502A include an attack instruction, a defense instruction, and a movement instruction.

When the instruction type is the movement instruction, operation 804 of determining a starting position feature and an ending position feature of the movement operation is performed.

For example, the starting position feature indicates a region, for example, an unsafe region or a safe region corresponding to a starting position in the virtual scene. In the unsafe region, a health point of the virtual object periodically decreases. On the contrary, the safe region is a region in the virtual scene in which the health point of the virtual object does not enter a periodically decreasing state.

For example, the ending position feature indicates a region (for example, an unsafe region or a safe region) corresponding to an ending position in the virtual scene and indicates whether a position marking control of a virtual object, a position marking control of a virtual carrier, or a marking point exists at the ending position (i.e., a circular region with the ending position as a center). The marking point is a point in the map configured for representing a position. As discussed above, FIG. 5D is a schematic diagram of a map of a method for message processing in a virtual scene according to an aspect of this application. In response to a triggering operation performed on a first marking control 501D in the map, a marking mode is entered. In response to a selection operation performed on any position in the map, a first customized marking point, for example, a first customized marking point D1, corresponding to the selected position is displayed. In response to a triggering operation performed on a second marking control 502D, a second customized marking point D2 is displayed at a position at which a position marking control X2 of the first virtual object is located. In FIG. 5D, the ending position feature corresponding to the movement operation is that a marking point exists in the safe region. The marking point is the first customized marking point D1.

Exemplarily, when a corresponding position marking control or marking point exists at the ending position, corresponding content related to the position marking control or the marking point exists in the message. For example, if the virtual carrier exists at the ending position, the message may include content such as “Board” and “Go to the carrier and board”. If the ending position is in the safe region, the message may include content such as “Enter the safe region”.

Operation 805: Obtain a corresponding message through matching in a message triggering condition library based on the starting position feature and the ending position feature.

Exemplarily, a triggering condition transmitted for each triggerable message is summarized into a database (the message triggering condition library) in advance. The message triggering condition library has messages and triggering conditions corresponding to the message stored therein. When the ending position feature (or the ending position feature and the starting position feature) of the movement operation satisfies the triggering condition corresponding to the message, the corresponding message is transmitted to a teammate corresponding to the moved teammate icon control. After a sliding operation performed on the teammate icon control is identified, a starting position and an ending position of the sliding operation are used as the triggering condition of the sliding operation, and the same triggering condition is obtained through matching in the message triggering condition library. The starting position is configured for determining behavior content (entering a circle/moving) of the virtual object in the transmitted message. The ending position is configured for determining a destination noun (a specified place/virtual object position/carrier) in the message.

A message corresponding to the movement instruction is used as an example. A relationship between a triggering condition and a message is as follows:

1. If a marking point exists at the ending position to which the teammate icon control is moved, and the starting position and the ending position are both in the safe region, a corresponding message is “Move to a position of the marking point”.

2. If a carrier exists at the ending position to which the teammate icon control is moved, and the starting position and the ending position are both in the safe region, a corresponding message is “Move to a position of the carrier and get on the carrier”.

3. If the ending position to which the teammate icon control is moved is a position of the first virtual object, a corresponding message is “Gather with me”.

4. If the starting position of the teammate icon control is outside the safe region, and the ending position is in the safe region, a corresponding message is “Enter the safe region”.

5. If the starting position of the teammate icon control is in the safe region, and another teammate icon control exists at the ending position to which the teammate icon control is moved, a corresponding message is “Gather with a teammate”.

In some aspects, when the instruction type is the movement instruction, different starting position features and ending position features correspond to different messages. Details are described below.

In response to a movement operation being performed on a teammate icon control of a specified teammate, a starting position of the movement operation being outside the safe region of the virtual scene in the map, and an ending position being within the safe region of the virtual scene in the map, a message “Enter the safe region as soon as possible” is transmitted to the specified teammate. As discussed above, FIG. 5C is a schematic diagram of a map of a method for message processing in a virtual scene according to an aspect of this application. The position marking control X3 is moved from outside of a safe region 501C to a position within the safe region 501C. In this case, the text message “Enter the safe region as soon as possible” may be transmitted to the specified teammate, and the ending position corresponding to the movement operation is displayed on a map interface corresponding to the specified teammate.

In response to a movement operation being performed on the teammate icon control of the specified teammate, a starting position of the movement operation being in the safe region, a place mark existing at the ending position, and the ending position being in the safe region of the virtual scene in the map, a message “Go to xxx (a specified place)” is transmitted to the specified teammate. The specified place is a position corresponding to the place mark, and the place mark is displayed prominently on the map interface of the specified teammate (for example, the place mark is displayed in a bold form, the place mark is displayed with a different color, or the place mark is highlighted). Similarly, if the teammate is outside the safe region, a message “Enter the safe region and go to xxx (a specified place)” is transmitted. If the ending position of the movement operation is the position at which the first virtual object is located, when no carrier exists at the position at which the first virtual object is located, a message “Gather with me” is transmitted to the specified teammate. When the carrier exists at the position at which the first virtual object is located, a message “Board as soon as possible” or “Board at xxx (a place) as soon as possible” is transmitted to the specified teammate. The place refers to a position in the virtual scene.

In some aspects, when the teammate icon control moves based on the movement operation, the server begins to compare the starting position feature of the movement operation with the triggering conditions in the message triggering condition library. When the movement operation ends, the server further queries a plurality of queried messages corresponding to the starting position feature based on the ending position feature of the movement operation, to obtain a matched triggering condition, and transmits a message corresponding to the matched triggering condition. For example, the position of the first virtual object corresponding to the user is located in the safe region, a movement operation is applied to a teammate icon control outside the safe region, and an ending position of the movement operation is a position at which the position marking control of the first virtual object is currently located. In this case, a condition “the starting position is outside the safe region and the ending position is within the safe region” and a condition “the ending position is the position corresponding to the first virtual object” are both satisfied. Therefore, a message with text content “Enter the safe region and gather with me as soon as possible” is transmitted to the teammate, and the position marking control corresponding to the first virtual object is displayed prominently (for example, the position marking control is highlighted, the position marking control is circled with an annotation box, or the position marking control is displayed with a different color or in a bold form) on the map interface corresponding to the second virtual object (which is a teammate receiving the message of the first virtual object), so that the user controls the second virtual object to go to the position at which the first virtual object is located.

Operation 806: Transmit a matched message to a teammate corresponding to the teammate icon control.

In one example, the message is transmitted when the movement operation is stopped (for example, the user stops moving the position marking control after moving the position marking control to a position) or released (for example, the user releases the finger pressing the position marking control).

A message transmission manner may include a voice message, a text message, and a mixture of the voice message and the text message. Manners of instructing the second virtual object through the message include the following:

1. Content of the message is displayed to the second virtual object in a form of a voice or a text, the content of the message including the instruction and the second position.

For example, text content of the text message is “Go to the building B (1234, 5678)”, “Building B (1234, 5678)” is the second position, “Go” represents a movement instruction, and (1234, 5678) is position coordinates of the building B on the map.

For another example, the text content of the text message is “Go to the second floor of the building A”. “Go” represents the movement instruction, and “the second floor of the building A” is a clear second position.

2. Content of the message including the instruction is displayed to the second virtual object in the form of a voice or a text, and at least one of the following is displayed on the map interface corresponding to the second virtual object: a position mark of the second position, a direction of the second position relative to the position marking control of the second virtual object, and a path between the position marking control of the second virtual object and the second position. In this manner, the voice message or the text message may not include the second position, or may not include a clear second position.

For example, FIG. 7B is a schematic diagram of a virtual scene interface corresponding to a second virtual object according to an aspect of this application. A map 702 is displayed at an upper right corner of a virtual scene 701. A picture related to the movement operation in the map corresponding to the first virtual object is synchronously displayed in the map 702 of the second virtual object, so that the message is more prominent, which facilitates timely response of a user corresponding to the second virtual object. In the virtual scene 701, text content 703 “Gather with the teammate 2” of the message, i.e., gather with the virtual object corresponding to the user transmitting the message is displayed. The teammate 2 is the first virtual object. The direction and the path between the position marking control of the second virtual object and the second position are shown in the map 702.

3. Content of the message is displayed to the second virtual object in a form of a voice or a text, the content of the message including the instruction and the second position. In addition, at least one of the following is displayed on the map interface corresponding to the second virtual object: a position mark of the second position, a direction of the second position relative to the position marking control of the second virtual object, and a path between the position marking control of the second virtual object and the second position.

For example, text content of the message is “Gather at xxx (a specified position) (1472, 2147)”. The text content is displayed in a form of a text or a voice on a human-machine interaction interface corresponding to the second virtual object, and a position mark of the specified position, a path between the position marking control of the second virtual object and the position mark corresponding to the specified position, and a direction of the specified position relative to the position marking control of the second virtual object are displayed in the map of the second virtual object. (1472, 2147) is position coordinates on the map corresponding to the specified position. FIG. 5F is a schematic diagram of a map of a method for message processing in a virtual scene according to an aspect of this application. The map interface of the second virtual object receiving the message synchronously displays a position mark 501F of the second position. The position mark 501F (which is a circle in FIG. 5F, and may be presented in a form such as a highlighted form or an annotation box during specific implementation, or may be marked with a different color, so that the second position is more prominent, thereby facilitating viewing by a user controlling the second virtual object) is displayed at the second position. Dashed lines between the position mark 501F and the position marking control X3 represent a path between the two, and an arrow from the position marking control X3 toward the position mark 501F represents a direction between the two.

Exemplarily, the position marking control is a control that moves on the map with a position of a marked object in the virtual scene. When the movement operation is released or stopped and the message is already transmitted to the corresponding teammate, the position marking control is returned to a current position of the second virtual object. Still referring to FIG. 5B, when the transmission of the message is completed, the position marking control X3′ at the second position is hidden. If the current position of the second virtual object remains at the first position during the message transmission, display of the position marking control X3 that exits the zoomed-in mode (exiting the zoomed-in mode means displaying the position marking control X3 in the original size) is recovered at the first position.

When the instruction type is the attack instruction, operation 807 of obtaining a corresponding message through matching in the message triggering condition library based on the ending position feature of the movement operation is performed.

Exemplarily, a manner of determining the ending position feature in operation 807 is the same as that in the above operation 804, and a message matching principle is the same as that in the above operation 805. Details are not described herein. The defense instruction and the attack instruction are both instructions for operating the virtual object. A message matching principle corresponding to the defense instruction is the same as that of the attack instruction. Details are not described herein.

In some aspects, in response to the movement operation performed on the teammate icon control of the specified teammate, when a marking point exists at the ending position of the movement operation, a message of “Attack the making position” is transmitted to the specified teammate. In response to the movement operation performed on the teammate icon control of the specified teammate, when a virtual object exists at the ending position of the movement operation, text content “Attack the enemy” is transmitted to the specified teammate, and a position mark of the second position at which the virtual object is located is synchronously displayed on the map interface corresponding to the specified teammate. FIG. 5E is a schematic diagram of a map of a method for message processing in a virtual scene according to an aspect of this application. A current instruction of the instruction control 502A in the selected state is the attack instruction. In this case, after the position marking control X3 is moved to the second position, a small icon of the attack instruction may be displayed at the second position. The small icon of the attack instruction is synchronously displayed on the map of the second virtual object, so that the second virtual object determines a to-be-attacked position. Referring to FIG. 5F, when the movement operation is released, the position mark 501F of the second position is displayed on the map interface of the first virtual object. In addition, the position mark 501F of the second position is synchronously displayed on the map interface corresponding to the second virtual object receiving the message.

In some aspects, for the defense instruction, in response to the movement operation performed on the teammate icon control of the specified teammate, when a marking point exists at the ending position of the movement operation, a message “Defend the making position” is transmitted to the specified teammate. In response to the movement operation performed on the teammate icon control of the specified teammate, when another teammate icon control exists at the ending position of the movement operation, a message “Protect xxx (a teammate)” is transmitted to the specified teammate. The teammate is a number or a name of the teammate.

In this aspect of this application, classification-based message query is performed based on the instruction type, which improves efficiency of querying the message triggering condition library for the message, and enables the message to be transmitted immediately when the movement operation is released or stopped, thereby improving message transmission efficiency.

After operation 807, operation 806 of transmitting a matched message to the teammate corresponding to the teammate icon control is performed.

A specific manner of transmitting the message is described above, and therefore is not described in detail herein again.

In this aspect of this application, the position marking control in the map of the virtual scene is reused, so that the user can quickly and conveniently transmit the point-to-point message to the teammate by performing the movement operation on the position marking control on the map representing the teammate. The point-to-point message transmission manner avoids interference with an irrelevant player (a player that does not need to receive the message), avoids a burden on an internal running memory of a client of the irrelevant player, saves graphic computing resources required for the virtual scene, is not limited by a radio device or a playback device, and achieves efficient message transmission in the virtual scene.

An exemplary structure of an apparatus 455 for message processing in a virtual scene provided in one or more aspects of this application implemented as a software module is further described below. In some aspects, as shown in FIG. 2, software modules in the apparatus 455 for message processing in a virtual scene stored in the memory 450 may include a display module 4551, configured to display a map of at least partial region of the virtual scene on a map interface corresponding to a first virtual object, the display module 4551 being further configured to display, in response to at least one second virtual object appearing in the partial region, a position marking control configured to represent a first position at which the second virtual object is currently located in the map, the second virtual object being any virtual object belonging to the same camp as the first virtual object; and a message transmission module 4552, configured to move the position marking control from the first position to a second position in response to a movement operation performed on the position marking control, and transmit a message to the second virtual object, the message carrying the second position and an instruction.

In some aspects, the message transmission module 4552 is further configured to: display an instruction control inside or outside the map, the instruction control including a plurality of types of candidate instructions; and use, in response to an instruction selection operation performed on any one of the candidate instructions of the instruction control, the selected candidate instruction as the instruction carried in the message.

In some aspects, the message transmission module 4552 is further configured to: maintain, in response to the instruction selection operation performed on any one of the candidate instructions of the instruction control, the selected candidate instruction in a selected state before a next instruction selection operation is received; or perform switching from displaying the selected candidate instruction in the selected state to displaying a default instruction in the selected state after the message is transmitted to the second virtual object, the default instruction being a candidate instruction of the plurality of types of candidate instructions set to be in an automatically selected state.

In some aspects, the message transmission module 4552 is further configured to: display an instruction control inside or outside the map, the instruction control including a plurality of types of candidate instructions, and one of the plurality of types of candidate instructions being in an automatically selected state; and use the candidate instruction in the automatically selected state as the instruction carried in the message in response to an instruction selection operation performed on any one of the candidate instructions of the instruction control being not received within a set duration.

In some aspects, the message transmission module 4552 is further configured to rank the plurality of candidate instructions in any one of the following manners when the instruction control includes the plurality of candidate instructions: performing ranking in descending order or ascending order based on a usage frequency of each candidate instruction; performing ranking based on an order in which each candidate instruction is set; and performing ranking in ascending order or descending order based on a usage probability of each candidate instruction.

In some aspects, the message transmission module 4552 is further configured to call a neural network model based on parameters of the virtual objects in the virtual scene to perform prediction, to obtain the usage probability corresponding to each candidate instruction. The parameters of the virtual object include at least one of a position and an attribute value of the first virtual object, the attribute value including a combat capability and a health point; a position and an attribute value of the second virtual object; and a difference between an attribute value of a camp to which the first virtual object belongs and an attribute value of a rival camp. The neural network model is trained based on battle data of at least two camps, the battle data including positions and attribute values of a plurality of virtual objects in the at least two camps, instructions executed by a virtual object of a victorious camp, and instructions executed by a virtual object of a defeated camp, and a label of each instruction executed by the virtual object of the victorious camp being a probability of 1, and a label of each instruction executed by the virtual object of the defeated camp being a probability of 0.

In some aspects, when a plurality of position marking controls are displayed in the map, the message transmission module 4552 is further configured to: display, in response to a selection operation performed on any one of the position marking controls, the selected position marking control in the selected state; and delete the position marking control in the selected state in response to a deletion operation performed on the position marking control in the selected state.

In some aspects, when a map of the partial region of the virtual scene is displayed on the map interface, the message transmission module 4552 is further configured to: display a position marking control of a non-present virtual object outside the map, the non-present virtual object being the second virtual object that currently does not appear in the partial region; move the position marking control from outside of the map to the second position in response to a movement operation performed on the position marking control of the non-present virtual object, and transmit a message to the non-present virtual object, the message being configured for instructing the non-present virtual object to arrive at the second position and execute an instruction.

In some aspects, when position marking controls configured to represent first positions at which a plurality of second virtual objects are currently located are displayed in the map, the message transmission module 4552 is further configured to: display a plurality of position marking controls in the selected state in response to a batch selection operation; and move the plurality of position marking controls from the first positions at which the plurality of position marking controls are respectively located to the second position in response to the movement operations, and transmit a message to the second virtual objects respectively corresponding to the plurality of position marking controls, the message being configured for instructing the second virtual objects respectively corresponding to the plurality of position marking controls to arrive at the second position and execute the instruction.

In some aspects, after transmitting the message to the second virtual object, the message transmission module 4552 is further configured to: display message transmission controls respectively corresponding to unmoved virtual objects in the map, the unmoved virtual objects being second virtual objects to which the message is not transmitted, and the message transmission controls being configured to repeatedly transmit the message; and transmit, in response to a triggering operation performed on any one of the message transmission controls, the message to the unmoved virtual object corresponding to the triggered message transmission control.

In some aspects, when a type of the instruction is a movement instruction and a virtual carrier exists at the second position, content of the message is to gather at the second position and enter the virtual carrier. When the type of the instruction is the movement instruction and the virtual carrier does not exist at the second position, the content of the message is to gather at the second position. When the type of the instruction is a defense instruction, the content of the message is to go to the second position and perform defense. When the type of the instruction is an attack instruction and the virtual carrier exists at the second position, the content of the message is to go to the second position and perform attack.

In some aspects, the message transmission module 4552 is further configured to transmit the message to the second virtual object in any one of the following manners: causing display of a message type selection control in response to the movement operation performed on the position marking control being released, the message type selection control including the following message types: a voice message, a text message, and a mixture of the voice message and the text message; transmitting, in response to a selection operation performed on the message type selection control, the message to the second virtual object based on a selected message type; and transmitting the message to the second virtual object based on a set message type in response to the movement operation performed on the position marking control being released.

In some aspects, before causing display of the map of at least partial region of the virtual scene on the map interface corresponding to the first virtual object, the display module 4551 is further configured to display the map interface in any one of the following manners: causing display of the virtual scene on a virtual scene interface, and causing display of the map interface on a floating layer covering a partial region of the virtual scene interface; and causing display of the virtual scene on the virtual scene interface, and causing display of the map interface in a region outside the virtual scene interface.

In some aspects, the map is a preview picture of all regions of the virtual scene, or the map is preview picture of a partial region of the virtual scene, the partial region being a region radiating outward with the first virtual object as a center.

In some aspects, the message transmission module 4552 is further configured to: display, in response to a duration of a pressing operation performed on the position marking control reaching a pressing duration threshold, the position marking control corresponding to the pressing operation in a zoomed-in mode; control the position marking control displayed in the zoomed-in mode to start to synchronously move from the first position in response to the movement operation performed on the position marking control; and move the position marking control displayed in the zoomed-in mode to the second position in response to the movement operation being released at the second position.

In some aspects, before transmitting the message to the second virtual object, the message transmission module 4552 is further configured to: determine a starting position feature and an ending position feature in the virtual scene corresponding to the movement operation based on the movement operation, the first position, and the second position, and use the starting position feature and the ending position feature as a triggering condition; and query a database based on the triggering condition for a message matching the triggering condition, the database having correspondences between different messages and different triggering conditions stored therein.

In some aspects, the message transmission module 4552 is further configured to: determine a first region in the virtual scene in which the first position is located and a second region in the virtual scene in which the second position is located; determine a mark type on the map interface corresponding to the second position, the mark type including no mark, a virtual object position mark, and a virtual carrier position mark; and use the first region as the starting position feature of the movement operation, and using the second region and the mark type as the ending position feature of the movement operation.

In some aspects, the message transmission module 4552 is further configured to: detect a partial region of the map with the second position as a center; use a mark type corresponding to a detected position marking control closest to the second position as the mark type on the map interface corresponding to the second position when at least one position marking control is detected; and use no mark as the mark type on the map interface corresponding to the second position when the position marking control is not detected.

In some aspects, the display module 4551 is further configured to display, in response to at least one virtual carrier appearing in the partial region, a position marking control in the map configured to represent that the virtual carrier is at the second position, a mark type of the position marking control of the virtual carrier being the virtual carrier position mark.

In some aspects, the message transmission module 4552 is further configured to: display a place marking mode being entered in response to a triggering operation performed on a first marking control in the map, and display a first customized marking point at a clicking/tapping position on the map in response to a clicking/tapping operation performed on the map, the first customized marking point being configured to be synchronously displayed on a map interface corresponding to the second virtual object; and display a second customized marking point at the first position in the map at which the first virtual object is currently located in response to a triggering operation performed on a second marking control in the map, the second customized marking point being configured to be synchronously displayed on the map interface corresponding to the second virtual object.

An aspect of this application provides a computer program product or a computer program, the computer program product or the computer program including computer instructions, the computer instructions being stored in a computer-readable storage medium. A processor of a computer device reads the computer instructions from the computer-readable storage medium, and the processor executes the computer instructions, to cause the computer device to perform the above method for message processing in a virtual scene in one or more aspects of this application.

An aspect of this application provides a readable storage medium, having executable instructions stored therein, the executable instructions, when executed by a processor, causing the processor to perform the method for message processing in a virtual scene provided in one or more aspects of this application, for example, the method for message processing in a virtual scene shown in FIG. 3A.

In some aspects, the computer storage medium may be a memory such as a ferromagnetic random access memory (FRAM), a read-only memory (ROM), a programmable random access memory (PROM), an erasable programmable random access memory (EPROM), an electrically erasable programmable random access memory (EEPROM), a flash memory, a magnetic surface memory, a compact disc, or a compact disc random access memory (CD-ROM), or may be various devices including one of or any combination of the above memories.

In some aspects, the executable instructions may adopt any form such as a program, a software, a software module, a script, or a code, may be written in a programming language of any form (including a compiled or interpreted language, or a declarative or procedural language), and may be deployed in any form, for example, deployed as a standalone program or as a module, a component, a subroutine, or another unit suitable for use in a computing environment.

In an example, the executable instructions may be deployed on one computing device for execution, executed on a plurality of computing devices at one position, or executed on a plurality of computing devices distributed at a plurality of positions and connected by a communication network.

In summary, in one or more aspects of this application, the position marking control of the second virtual object in the same camp as the first virtual object is displayed in the map, or the position marking control of the second virtual object is displayed outside the map, and when the position marking control of the second virtual object is moved, the corresponding instruction and message are transmitted to the second virtual object based on the movement operation, which achieves shortcut transmission of the point-to-point message by using the map interface of the virtual scene without a need of voice transmission or text input. Instead, merely dragging the position marking control can achieve shortcut message transmission, thereby reducing time required for message transmission. In addition, through message transmission to only the second virtual object, precise point-to-point message transmission is achieved, and interference with other virtual objects in the same camp is avoided. Moreover, the position marking control on the map interface of the virtual scene is reused without a need to arrange a new control configured to transmit a message on a human-computer interaction interface, and point-to-point message transmission can be achieved without a need to use a radio device (for example, a microphone), thereby reducing computing resources required for the virtual scene.

The above descriptions are merely one or more aspects of this application and are not intended to limit the protection scope of this application. Any modification, equivalent replacement, or improvement made without departing from the spirit and principle of this application falls within the protection scope of this application.

What is claimed is:

1. A method comprising:
causing display of a map of at least a partial region of a virtual scene on a map interface corresponding to a first virtual object;
causing display of, in response to at least one second virtual object appearing in the partial region, a position marking control configured to represent a first position at which the second virtual object is currently located in the map, the second virtual object belonging to a same camp as the first virtual object; and
moving the position marking control from the first position to a second position in response to a movement operation performed on the position marking control; and
transmitting a message to the second virtual object, the message configured to instruct the second virtual object to move to the second position and execute an instruction.

2. The method according to claim 1, further comprising:
causing display of, before the moving, an instruction control comprising a plurality of types of candidate instructions; and
using, in response to an instruction selection operation performed on any one of the candidate instructions of the instruction control, the selected candidate instruction as the instruction in the message.

3. The method according to claim 2, further comprising:
maintaining, in response to the instruction selection operation performed on any one of the candidate instructions of the instruction control, the selected candidate instruction in a selected state before a next instruction selection operation is received; or
performing switching from causing display of the selected candidate instruction in the selected state to causing display of a default instruction in the selected state after the message is transmitted to the second virtual object, the default instruction being a candidate instruction of the plurality of types of candidate instructions set to be in an automatically selected state.

4. The method according to claim 1, further comprising:
causing display of, prior to the moving, an instruction control comprising a plurality of types of candidate instructions, wherein one of the plurality of types of candidate instructions is in an automatically selected state; and
using the candidate instruction in the automatically selected state as the instruction included in the message in response to an instruction selection operation performed on any one of the candidate instructions of the instruction control not being received within a set duration.

5. The method according to claim 2, further comprising ranking the plurality of candidate instructions, wherein the ranking comprises one of:
a descending order or ascending order based on a usage frequency of each candidate instruction;
an order in which each candidate instruction is set; or
an ascending order or descending order based on a usage probability of each candidate instruction.

6. The method according to claim 5, further comprising:
predicting a usage probability corresponding to each candidate instruction via a neural network model that uses parameters of the virtual objects in the virtual scene,
wherein the parameters of the virtual objects comprise at least one of:
a position and an attribute value of the first virtual object, the attribute value comprising a combat capability and a health point;
a position and an attribute value of the second virtual object; or
a difference between an attribute value of the camp to which the first virtual object belongs and an attribute value of a second camp.

7. The method according to claim 6, further comprising:
training, prior to the predicting, the neural network model based on battle data of at least two camps, the battle data comprising positions and attribute values of a plurality of virtual objects in the at least two camps, instructions executed by a virtual object of a victorious camp, and instructions executed by a virtual object of a defeated camp, wherein a label of each instruction executed by the virtual object of the victorious camp being a probability of 1, and a label of each instruction executed by the virtual object of the defeated camp being a probability of 0.

8. The method according to claim 1, wherein a plurality of position marking controls are displayed in the map, the method further comprising:
causing display of, in response to a selection operation performed on any one of the position marking controls, the selected position marking control in the selected state; and
deleting the position marking control in the selected state in response to a deletion operation performed on the position marking control in the selected state.

9. The method according to claim 1, wherein the map of the partial region of the virtual scene is displayed on the map interface, the method further comprising:
causing display of a position marking control of a non-present virtual object outside the map, the non-present virtual object being the second virtual object that currently does not appear in the partial region;
moving the position marking control from outside of the map to the second position in response to a movement operation performed on the position marking control of the non-present virtual object; and
transmitting a message to the non-present virtual object, the message being configured for instructing the non-present virtual object to arrive at the second position and execute the instruction.

10. The method according to claim 1, wherein position marking controls configured to represent first positions at which a plurality of second virtual objects are currently located are displayed in the map,
wherein the moving comprises:
causing display of a plurality of position marking controls in the selected state in response to a batch selection operation;
moving the plurality of position marking controls from the first positions at which the plurality of position marking controls are respectively located to the second position in response to the movement operation; and
wherein the transmitting further comprises transmitting the message to the second virtual objects respectively corresponding to the plurality of position marking controls, the message being configured for instructing the second virtual objects respectively corresponding to the plurality of position marking controls to arrive at the second position and execute the instruction.

11. The method according claim 1, further comprising:
causing display of message transmission controls respectively corresponding to unmoved virtual objects in the map, the unmoved virtual objects being third virtual objects to which the message is not transmitted, and the message transmission controls being configured to repeatedly transmit the message; and
transmitting, in response to a triggering operation performed on any one of the message transmission controls, the message to an unmoved virtual object corresponding to the triggered message transmission control.

12. The method according to claim 1, further comprising transmitting the message to the second virtual object by:
causing display of a message type selection control in response to the movement operation performed on the position marking control being released and transmitting, in response to a selection operation performed on the message type selection control, the message to the second virtual object based on a selected message type, the message type selection control comprising a voice message, a text message, or a mixture of the voice message and the text message; or
transmitting the message to the second virtual object based on a set message type in response to the movement operation performed on the position marking control being released.

13. The method according to claim 1, wherein before causing display of the map of at least a partial region of the virtual scene on a map interface corresponding to a first virtual object, the method further comprises causing display of the map interface by:
causing display of the virtual scene on a virtual scene interface, and causing display of the map interface on a floating layer covering a partial region of the virtual scene interface; or
causing display of the virtual scene on the virtual scene interface, and causing display of the map interface in a region outside the virtual scene interface.

14. The method according to claim 1, wherein the moving comprises:
causing display of, in response to a duration of a pressing operation performed on the position marking control reaching a pressing duration threshold, the position marking control corresponding to the pressing operation in a zoomed-in mode;
controlling the position marking control displayed in the zoomed-in mode to start to synchronously move from the first position in response to the movement operation performed on the position marking control; and
moving the position marking control displayed in the zoomed-in mode to the second position in response to the movement operation being released at the second position.

15. The method according to claim 1, wherein before the transmitting, the method further comprises:
determining a starting position feature and an ending position feature in the virtual scene corresponding to the movement operation based on the movement operation, the first position, and the second position;
using the starting position feature and the ending position feature as a triggering condition; and
querying a database based on the triggering condition for a message matching the triggering condition, the database having correspondences between different messages and different triggering conditions stored therein.

16. The method according to claim 15, wherein the determining comprises:
determining a first region in the virtual scene in which the first position is located and a second region in the virtual scene in which the second position is located;
determining a mark type on the map interface corresponding to the second position, the mark type comprising no mark, a virtual object position mark, or a virtual carrier position mark; and
using the first region as the starting position feature and the second region and the mark type as the ending position feature.

17. The method according to claim 16, wherein the determining a mark type on the map interface corresponding to the second position comprises:
detecting a partial region of the map with the second position as a center;
using a mark type corresponding to a detected position marking control closest to the second position as the mark type on the map interface corresponding to the second position when at least one position marking control is detected; and
using no mark as the mark type on the map interface corresponding to the second position when the position marking control is not detected.

18. The method according to claim 17, further comprising:
causing display of, in response to at least one virtual carrier appearing in the partial region, a position marking control in the map configured to represent that the virtual carrier is at the second position, a mark type of the position marking control of the virtual carrier being the virtual carrier position mark.

19. An apparatus comprising:
one or more processors;
memory storing computer-readable instructions which, when executed by the one or more processors, cause the apparatus to:
cause display of a map of at least a partial region of a virtual scene on a map interface corresponding to a first virtual object;
cause display of, in response to at least one second virtual object appearing in the partial region, a position marking control configured to represent a first position at which the second virtual object is currently located in the map, the second virtual object belonging to a same camp as the first virtual object; and
move the position marking control from the first position to a second position in response to a movement operation performed on the position marking control; and
transmit a message to the second virtual object, the message configured to instruct the second virtual object to move to the second position and execute an instruction.

20. One or more non-transitory computer-readable storing media storing instructions that, when executed by one or more processors, cause the one or more processors to:
cause display of a map of at least a partial region of a virtual scene on a map interface corresponding to a first virtual object;
cause display of, in response to at least one second virtual object appearing in the partial region, a position marking control configured to represent a first position at which the second virtual object is currently located in the map, the second virtual object belonging to a same camp as the first virtual object; and move the position marking control from the first position to a second position in response to a movement operation performed on the position marking control; and
transmit a message to the second virtual object, the message configured to instruct the second virtual object to move to the second position and execute an instruction.
